(19) United States
(12) Patent Application Publication
(10) Pub. No.: US 2002/0108125 A1
(43) Pub. Date: Aug. 8, 2002

(54) Apparatus and method for facilitating viewer or listener interaction

(76) Inventor: Raymond Anthony Joao, Yonkers, NY (US)

Correspondence Address: RAYMOND A. JOAO, ESQ., 122 BELLEVUE PLACE, YONKERS, NY, 10703, US

(21) Appl. No.: 10/067,655

(22) Filed: Feb. 5, 2002

Related U.S. Application Data
(60) Provisional application No. 60/267,010, filed on Feb. 7, 2001.

(51) Int. Cl. H04N 7/16

(52) U.S. Cl. 725/139; 725/140; 725/135; 725/105

(57) ABSTRACT

An apparatus and method for facilitating viewer and/or listener interaction, including a receiver for receiving a broadcast of a program, an event, a game, and information, from a broadcasting system, or a transmission of information from a central processing computer, a communication device for facilitating communication between a viewer or listener and a participant in, or an individual located at a venue of, the program, event, or game, an input device for inputting viewer or listener interactive information or viewer or listener participation information, a processor for processing the viewer or listener interactive information or viewer or listener participation information, and a transmitter for transmitting the viewer or listener interactive information or viewer or listener participation information to the central processing computer.

### RELATED APPLICATIONS

This application claims the benefit of priority of U.S. Provisional Patent Application Serial No. 60/267,010, filed Feb. 7, 2001, and entitled “APPARATUS AND METHOD FOR FACILITATING VIEWER OR LISTENER INTERACTION”, the subject matter of which is hereby incorporated by reference herein.

### FIELD OF THE INVENTION

The present invention pertains to an apparatus and method for facilitating viewer or listener interaction and, in particular, to an apparatus and method for facilitating viewer or listener interaction with, viewer or listener participation in, and/or viewer or listener control over the presentation of, a program, an event, a game, and/or marketing information.

### BACKGROUND OF THE INVENTION

Millions of individuals watch a television and/or listen to a radio each day. Conventional televisions and radios have long been known to be devices which typically receive, and provide, for a respective viewer or listener, a one-way transmission or a broadcast of a program, an event, a game, a sporting event, or any one of a multitude of other broadcasts and/or presentations. Typically, the respective viewers or listeners have been unable to interact with the programs, events, games, and/or other broadcasts, thereby depriving the respective viewer or listener of the ability to interact with, and/or to participate in, same.

Many benefits can be realized from viewer or listener interaction with, and/or participation in, television and/or radio programs, events, games, and/or other broadcasts. The benefits can include, among countless others, increased interests in these programs, increased viewer-ship or listener-ship, the ability for programmers, advertisers, marketers, and/or other entities, to reach viewers or listeners in a more profound and/or personal way, and/or an enhanced ability to obtain valuable market research information. There is no doubt that viewer or listener interactivity and/or participation can drastically change the dynamics of television viewer-ship or radio listener-ship.

While the tremendous growth in the use of computers, personal computers, the Internet, and/or the World Wide Web, has begun to offer a glimpse into the benefits which can be obtained or realized by user interactivity, television and radio broadcasting still provides a much larger and more greatly enhanced platform from which to realize the benefits of viewer and/or listener interactivity and/or participation.

While interactive televisions and, to some extent, interactive radios, have been described as being capable of providing or facilitating certain limited interactivity applications, these systems, devices, and/or methods, have addressed only very limited applications and have failed to identify and/or to realize the tremendous potential of the many possible applications for user, viewer, and/or listener, interactivity which could lie ahead.

As a result, there is a great need for systems, devices, and/or methods, for facilitating user, viewer, and/or listener, interactivity with broadcasts or other media which can provide for enhanced user, viewer, and/or listener, interactivity with, and/or participation in, same, and which can more effectively tap the tremendous potential of these and related technological areas.

### SUMMARY OF THE INVENTION

The present invention pertains to an apparatus and method for facilitating viewer or listener interaction which overcomes the shortfalls of the prior art. The present invention pertains to an apparatus and method for facilitating viewer or listener interaction with, viewer or listener participation in, and/or viewer or listener control over the presentation of, a program, an event, a game, and/or marketing information.

The apparatus and method of the present invention can be utilized in conjunction with interactive televisions, interactive personal computers, interactive computers, telephones, video telephones, personal communication devices, two-radios, radio receivers having the capability to communicate with the broadcasting entity, and/or any other device which can receive video information, audio information, audio visual information, text information, multimedia information, and which can facilitate the interactive functionality described herein as being provided by the apparatus and method of the present invention.

The apparatus of the present invention can include a central broadcasting system(s), a user interactive device(s), and/or a location broadcasting system(s). Each of the central broadcasting system(s), the user interactive device(s), and/or the location broadcasting system(s), can include any of the systems, components, and/or devices, needed and/or desired for their respective operations.

The apparatus can be utilized on, over, and/or in conjunction with, a cable television system, or other suitable television broadcasting system, which can facilitate the utilization of interactive televisions and/or any of the other user devices described herein, in an interactive television and/or interactive broadcasting system or environment. The apparatus can also be utilized on, over, and/or in conjunction with a wireless communication network or system.

The present invention can also be utilized on, over, and/or in conjunction with, any one or more of a telephone network, a telecommunication network, a television broadcasting network, a television network, a power distribution network, a digital communication network, a satellite communication network, a wireless communication network, a personal communication services network, a broadband communication network, a bluetooth communication network, the Internet, the World Wide Web, and/or any other communication network and/or system.

The present invention can be utilized in order to facilitate viewer or listener interaction with a program, programs, an event, events, a game, games, a sporting event, sporting events, a television program, television programs, a television show, television shows, a television game show, television game shows, a movie, movies, a radio program, radio programs, a marketing program, marketing programs, an infomercial, infomercials, marketing information, a commercial, and/or commercials. The present invention can also be utilized in conducting transactions of any kind or type.

The present invention can also be utilized in order to facilitate user or viewer interaction with advertisements, and/or user or viewer selection of advertisements. The present invention can also be utilized in order to perform targeted advertising and/or marketing activities. The present invention can also be utilized in order to perform market research and/or to gather market research information.

The present invention can be utilized in order to provide for a compensation-based viewer or listener interaction. In this embodiment, the viewer can be compensated and/or otherwise paid for his or her interactivity and/or participation in programs, events, games, commercials, advertisements, surveys, and/or marketing activities, provided to the viewer.

The present invention can also be utilized in order to enable a viewer to participate in a program, event, and/or game. The viewer can participate in a program, television show, news broadcast, event, performance, television game show, game show, radio game show, game, contest, and/or sporting event. The viewer can communicate with actors, hosts, directors, newscasters, broadcasters, event performers, performers, game contestants, game players, athletes, professional sports athletes, professional sports players, amateur sports athletes, amateur sports players, and/or any other individuals, participating in and/or located at the respective set, studio, performance hall, event venue, stadium, arena, and/or other venue.

The present invention can also be utilized in order to allow users or viewers to assist or help participants in a program, event, or game. The present invention can also be utilized in order to allow users or viewers to share in prizes, winnings, and/or compensation, which can be provided by the respective program, event, or game.

The present invention can also be utilized in order to allow viewers, listeners, and/or spectators, to participate in, to engage in, and/or to play in, game strategy games and/or to engage in game strategy contests or exercises, for recreational purposes, for training purposes, and/or for any other purpose or purposes.

The present invention can also be utilized in order to allow a viewer to select and/or control the presentation of the program, event, or game. The present invention can be utilized in order to allow a viewer to select and/or control the selection of any one or more of cameras, video cameras, television cameras, video recorders, microphones, and/or audio recorders, which are utilized in the broadcast of any one or more of the herein-described programs, television programs, television shows, radio programs, news broadcasts, events, performances, television game shows, game shows, games, contests, and/or sporting events.

The present invention can also be utilized in order to allow a user or viewer to select the camera, microphone, and/or vantage point or location, from which the user, viewer, or listener, desires to view or listen to a program, an event, or a game. A viewer can select the camera angles from which he or she desires or view a program, an event, or a game (i.e. a viewer watching a game can select the cameras via which he or she wants to view a play or a portion of the game).

The present invention can also allow a viewer to request and receive instant replays, on-demand, and/or instant replays recorded by multiple cameras and/or microphones.

The present invention can be utilized in order to conduct elections and/or to vote in elections, of any kind. The apparatus can be utilized by users, individual, or viewers, to vote in elections for public offices, organization elections, corporate and/or private elections, union elections, and/or any other elections or campaigns.

The present invention can also administer and/or maintain a financial account(s) for, or on behalf of, any of the users, individuals, viewers, listeners, broadcasters, media providers, team owners, producers, disseminators and/or sponsors, of any respective program, event, game, commercial, advertisement, and/or marketing information, and/or advertisers or marketers, who or which utilize the present invention.

The present invention can also make a payment and/or a transfer for, or on behalf of, any of the herein-described and/or herein-defined users, individuals, viewers, listeners, broadcasters, media providers, team owners, producers, disseminators and/or sponsors, of any respective program, event, game, commercial, advertisement, and/or marketing information, and/or advertisers or marketers, and/or can receive a payment and/or a transfer for, or on behalf of, any of the herein-described and/or herein-defined users, individuals, viewers, listeners, broadcasters, media providers, team owners, producers, disseminators and/or sponsors, of any respective program, event, game, commercial, advertisement, and/or marketing information, and/or advertisers or marketers.

Intelligent agents, software agents, mobile agents, and/or related technologies, can be utilized in conjunction with the present invention.

The apparatus of the present invention, in any and/or all of the embodiments described herein, can also be programmed to be self-activating and/or activated automatically.

Accordingly, it is an object of the present invention to provide an apparatus and method for facilitating viewer or listener interaction.

It is another object of the present invention to provide an apparatus and method for facilitating viewer interaction.

It is still another object of the present invention to provide an apparatus and method for facilitating listener interaction.

It is yet another object of the present invention to provide an apparatus and method for facilitating viewer or listener interaction with a program, an event, a game, and/or marketing information.

It is another object of the present invention to provide an apparatus and method for facilitating viewer or listener participation in a program, an event, a game, and/or marketing information.

It is still another object of the present invention to provide an apparatus and method for facilitating viewer or listener control over the presentation of a program, an event, a game, and/or marketing information.

It is yet another object of the present invention to provide an apparatus and method for facilitating viewer or listener interaction which can be utilized in conjunction with any one or more of an interactive television, an interactive personal computer, an interactive computer, a telephone, a videophone, a personal communication device, a two-radio, and/or a radio.

It is another object of the present invention to provide an apparatus and method for facilitating viewer or listener interaction with a broadcasting system.

It is still another object of the present invention to provide an apparatus and method for facilitating viewer or listener interaction which can be utilized on, over, or in conjunction with, a cable television system.

It is yet another object of the present invention to provide an apparatus and method for facilitating viewer or listener interaction which can be utilized on, over, or in conjunction with, a wireless communication network or system.

It is another object of the present invention to provide an apparatus and method for facilitating viewer or listener interaction which can be utilized on, over, or in conjunction with, any one or more of a telephone network, a telecommunication network, a television broadcasting network, a television network, a power distribution network, a digital communication network, a satellite communication network, a wireless communication network, a personal communication services network, a broadband communication network, a bluetooth communication network, the Internet, the World Wide Web, and/or any other communication network and/or system.

It is still another object of the present invention to provide an apparatus and method for facilitating viewer or listener interaction with any one or more of a program, an event, a game, a sporting event, a television program, a television show, a television game show, a movie, a radio program, a marketing program, an infomercial, marketing information, and/or a commercial.

It is yet another object of the present invention to provide an apparatus and method for facilitating viewer or listener interaction which can be utilized to conduct transactions of any kind or type.

It is another object of the present invention to provide an apparatus and method for facilitating viewer or listener interaction with advertisements.

It is still another object of the present invention to provide an apparatus and method for facilitating viewer or listener interaction which can provide for viewer selection of advertisements.

It is yet another object of the present invention to provide an apparatus and method for facilitating viewer or listener interaction which can be utilized in order to perform targeted advertising and/or marketing activities.

It is another object of the present invention to provide an apparatus and method for facilitating viewer or listener interaction which can be utilized in order to perform market research.

It is still another object of the present invention to provide an apparatus and method for facilitating viewer or listener interaction which can provide for compensation-based viewer or listener interaction.

It is yet another object of the present invention to provide an apparatus and method for facilitating viewer or listener interaction which can provide compensation to a viewer or listener for his or her interactivity and/or participation in any one or more of a program, event, game, commercial, advertisement, survey, and/or marketing activity.

It is another object of the present invention to provide an apparatus and method for facilitating viewer or listener interaction which can enable or allow a viewer or listener to participate in a program, event, and/or game.

It is still another object of the present invention to provide an apparatus and method for facilitating viewer or listener interaction which can enable or allow a viewer or listener to participate in any one or more of a program, television show, news broadcast, event, performance, television game show, game show, radio game show, game, contest, and/or sporting event.

It is yet another object of the present invention to provide an apparatus and method for facilitating viewer or listener interaction which can enable or allow a viewer or listener to communicate with any one or more of actors, hosts, directors, newscasters, broadcasters, event performers, performers, game contestants, game players, athletes, professional sports athletes, professional sports players, amateur sports athletes, amateur sports players, and/or any other individuals, participating in and/or located at the respective set, studio, performance hall, event venue, stadium, arena, and/or other venue.

It is another object of the present invention to provide an apparatus and method for facilitating viewer or listener interaction which can enable or allow a viewer or listener to assist or help participants in any one or more of a program, event, or game.

It is still another object of the present invention to provide an apparatus and method for facilitating viewer or listener interaction which can enable or allow viewers or listeners to share in prizes, winnings, and/or compensation, which can be provided by a respective program, event, or game.

It is yet another object of the present invention to provide an apparatus and method for facilitating viewer or listener interaction which can be utilized in order to enable or allow viewers, listeners, and/or spectators, to participate in, to engage in, and/or to play in, game strategy games and/or to engage in game strategy contests or exercises.

It is another object of the present invention to provide an apparatus and method for facilitating viewer or listener interaction which can be utilized in order to enable or allow a viewer or listener to select and/or to control the presentation of the program, event, or game.

It is still another object of the present invention to provide an apparatus and method for facilitating viewer or listener interaction which can be utilized in order to enable or allow a viewer to select and/or to control the selection of any one of more of cameras, video cameras, television cameras, video recorders, microphones, and/or audio recorders, which are utilized in the broadcast.

It is yet another object of the present invention to provide an apparatus and method for facilitating viewer or listener interaction which can be utilized in order to enable or allow a viewer or listener to select the camera, microphone, and/or vantage point or location, from which the viewer or listener desires to view or listen to a program, an event, or a game.

It is another object of the present invention to provide an apparatus and method for facilitating viewer or listener interaction which can be utilized in order to enable or allow a viewer or listener to select a camera angle from which he or she desires or view a program, an event, or a game.

It is still another object of the present invention to provide an apparatus and method for facilitating viewer or listener interaction which can be utilized in order to enable or allow a viewer or listener to select or order an instant replay of a portion or a program, an event, or game.

It is yet another object of the present invention to provide an apparatus and method for facilitating viewer or listener interaction which can be utilized in order to enable or allow a viewer or listener to select or order an instant replay of a portion or a program, an event, or game, on-demand.

It is yet another object of the present invention to provide an apparatus and method for facilitating viewer or listener interaction which can be utilized in order to conduct elections and/or to vote in elections.

It is another object of the present invention to provide an apparatus and method for facilitating viewer or listener interaction which can administer and/or maintain a financial account(s) for, or on behalf of, any of the users, individuals, viewers, listeners, broadcasters, media providers, team owners, producers, disseminators and/or sponsors, of any respective program(s), event(s), game(s), commercial(s), advertisement(s), and/or marketing information, and/or advertisers or marketers, who or which utilize the present invention.

It is still another object of the present invention to provide an apparatus and method for facilitating viewer or listener interaction which can make a payment and/or a transfer for, or on behalf of, any user, individual, viewer, listener, broadcaster, media provider, team owner, producer, disseminator and/or sponsor, of any respective program(s), event(s), game(s), commercial(s), advertisement(s), and/or marketing information, and/or advertiser or marketer.

It is yet another object of the present invention to provide an apparatus and method for facilitating viewer or listener interaction which can receive a payment and/or a transfer for, or on behalf of, any user, individual, viewer, listener, broadcaster, media provider, team owner, producer, disseminator and/or sponsor, of any respective program(s), event(s), game(s), commercial(s), advertisement(s), and/or marketing information, and/or advertiser or marketer.

It is yet another object of the present invention to provide an apparatus and method for facilitating viewer or listener interaction which can utilize intelligent agents, software agents, mobile agents, and/or related technologies.

It is another object of the present invention to provide an apparatus and method for facilitating viewer or listener interaction which can be programmed to be self-activating and/or activated automatically.

Other objects and advantages of the present invention will be apparent to those skilled in the art upon a review of the Description of the Preferred Embodiments taken in conjunction with the Drawings which follow.

### BRIEF DESCRIPTION OF THE DRAWINGS

In the Drawings:

FIG. 1 illustrates the apparatus of the present invention, in block diagram form;

FIG. 2 illustrates the central broadcasting system of FIG. 1, in block diagram form;

FIG. 3 illustrates the user interactive device of FIG. 1, in block diagram form;

FIG. 4 illustrates the location broadcasting system of FIG. 1, in block diagram form;

FIG. 5 illustrates a preferred embodiment method for utilizing the apparatus of the present invention, in flow diagram form;

FIG. 6 illustrates another preferred embodiment method for utilizing the apparatus of the present invention, in flow diagram form;

FIG. 7 illustrates still another preferred embodiment method for utilizing the apparatus of the present invention, in flow diagram form;

FIG. 8 illustrates yet another preferred embodiment method for utilizing the apparatus of the present invention, in flow diagram form;

FIG. 9 illustrates another preferred embodiment method for utilizing the apparatus of the present invention, in flow diagram form; and

FIG. 10 illustrates still another preferred embodiment method for utilizing the apparatus of the present invention, in flow diagram form.

### DESCRIPTION OF THE PREFERRED EMBODIMENTS

The present invention pertains to an apparatus and method for facilitating viewer or listener interaction and, in particular, to an apparatus and method for facilitating viewer or listener interaction with, viewer or listener participation in, and/or viewer or listener control over the presentation of, a program, an event, a game, and/or marketing information.

The apparatus and method of the present invention can facilitate viewer or listener interaction with a program, programs, an event, events, a game, games, a sporting event, sporting events, a television program, television programs, a television show, television shows, a television game show, television game shows, a movie, movies, a radio program, radio programs, a marketing program, marketing programs, an infomercial, infomercials, marketing information, a commercial, and/or commercials. The apparatus and method of the present invention can also be utilized in conducting transactions of any kind or type.

The apparatus and method of the present invention can also be utilized in order to facilitate user or viewer or listener interaction with advertisements, and/or user or viewer selection of advertisements. The apparatus and method of the present invention can also be utilized in order to perform targeted advertising and/or marketing activities. The apparatus and method of the present invention can also be utilized in order to perform market research and/or to gather market research information.

The apparatus and method of the present invention can facilitate viewer or listener participation in a program, programs, an event, events, a game, games, a sporting event, sporting events, a television program, television programs, a television show, television shows, a television game show, television game shows, a movie, movies, a radio program, radio programs, a marketing program, marketing programs, an infomercial, infomercials, marketing information, a commercial, and/or commercials. The apparatus and method of the present invention can facilitate user or viewer or listener communication(s) with participants of a program, event, or game.

The apparatus and method of the present invention can also be utilized in order to facilitate user or viewer participation in games, television, radio, and/or other media, games, contests, and/or sporting events. The apparatus of the present invention can also be utilized in order to allow users or viewers to assist or help participants in a program, event, or game. The apparatus of the present invention can also be utilized in order to allow users or viewers to share in prizes, winnings, and/or compensation, which can be provided by the respective program, event, or game.

The apparatus and method of the present invention can also be utilized in order to allow users or viewers to participate in game strategy exercises or games.

The apparatus and method of the present invention can also facilitate viewer or listener control over the presentation of a program, programs, an event, events, a game, games, a sporting event, sporting events, a television program, television programs, a television show, television shows, a television game show, television game shows, a movie, movies, a radio program, radio programs, a marketing program, marketing programs, an infomercial, infomercials, marketing information, a commercial, and/or commercials.

The apparatus and method of the present invention can also be utilized in order to allow a user or viewer to select the camera, microphone, and/or vantage point or location from which the user or viewer desires to view or listen to a program, an event, or a game. A viewer can select the camera angles from which he or she desires or view a program, an event, or a game (i.e. a viewer watching a football game can select the cameras via which he or she wants to view a play or a portion of the game).

The apparatus and method of the present invention can also be utilized in order to order or control the viewing of instant replays, the viewing of a program, event, or game, or portion thereof, in split screen or multiple screen format in order to allow for the viewing of the instant replay as well as the broadcast. The apparatus and method of the present invention can also be utilized in order to order video and/or audio recordings of a program, event, or game, or portions thereof.

The apparatus and method of the present invention can be utilized in order to conduct elections and/or to effectuate voting over the communication network being utilized.

The apparatus and method of the present invention can be utilized in conjunction with interactive televisions, interactive personal computers, interactive computers, telephones, video telephones, personal communication devices, two-radios, radio receivers having the capability to communicate with the broadcasting entity, and/or any other device which can receive video information, audio information, audio visual information, text information, multimedia information, and which can facilitate the interactive functionality described herein as being provided by the apparatus and method of the present invention.

The apparatus and method of the present invention can also be utilized by a viewer to select and/or control the viewer's viewing and/or listening vantage point, to select to view and/or hear an instant replay or recording of previously presented material, and/or to select and/or control any viewing or listening functionality related to the respective program, programs, an event, events, a game, games, a sporting event, sporting events, marketing information, a commercial, and/or commercials.

The apparatus and method of the present invention, in a preferred embodiment, can be utilized in conjunction with an interactive television or interactive televisions. In another preferred embodiment, the apparatus and method of the present invention can be utilized in conjunction with any one or more of a computer, a personal computer, a telephone, a wireless telephone, a personal digital assistant, a video telephone, a videophone, a radio, a personal communication device, a wireless device, a handheld device, a palm-top device, a watch, a two-way radio, and/or any other communication device(s) and/or computer(s).

As defined herein, the terms “user”, “individual”, “viewer”, “fan”, “spectator”, or the plural of same, refer to any users, individuals, viewers, fans, spectator, and/or any other parties and/or entities who or which utilize the apparatus and method of the present invention.

As used herein, the terms “operator”, “administrator”, or the plural of same, refers to any of the operators, administrators, media broadcasters, media providers, television providers, television services providers, cable television providers, cable television services providers, Internet service providers, and/or other parties and/or entities who or which operate and/or administrate the operation of any of the central broadcasting systems described herein.

As used herein, the terms “broadcaster”, “producer”, “production company”, “production entity”, “media provider”, “media company”, “advertiser”, “advertisement production company”, “program producer”, “program owner”, “team owner”, “event promoter”, and/or like entities, and/or the plurals of same, refers to any company, companies, television company, television companies, television provider(s), cable television provider(s), cable television broadcaster(s), Internet services provider(s), individual, individuals, entity, and/or entities, who or which produces, provides, disseminates, and/or broadcasts, any of the herein-described programs, events, games, sporting events, television programs, television shows, television game shows, movies, radio programs, marketing programs, infomercials, marketing information, and/or commercials.

Applicant hereby incorporates by reference herein the subject matter and teachings of U.S. Provisional Patent Application Serial No. 60/267,010 which teaches and discloses an apparatus and method for facilitating viewer or listener interaction.

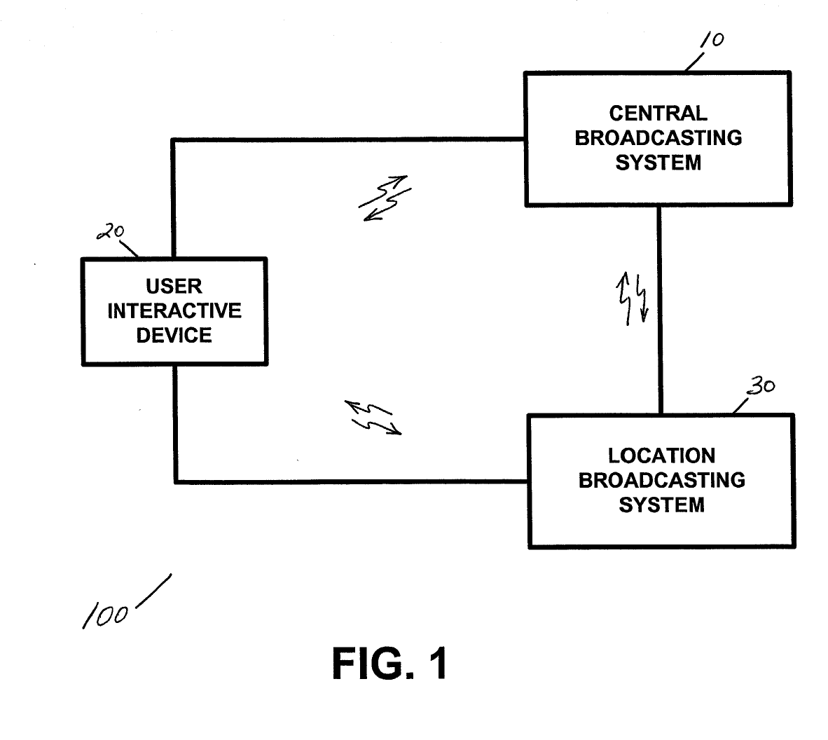

FIG. 1 illustrates the apparatus of the present invention, which is designated generally by the reference lock diagram form. With reference to FIG. 1, the apparatus 100 includes a central broadcasting system 10 which, in the preferred embodiment, can be associated with a media broadcaster such as, for example, a cable television broadcasting company. The central broadcasting system 10 can also be associated with any of the operators or administrators described herein.

The central broadcasting system 10 can be, or can be a component of, a cable television broadcasting system and/or a media broadcasting system. The central broadcasting system 10 can perform any of the functionality and/or processing routines described herein as being performed and/or provided by the central broadcasting system 10 and/or the apparatus 100.

Any number of central broadcasting systems 10, which can be associated with any number of operators, broadcasters, etc., can be utilized in conjunction with the present invention.

With reference to FIG. 1, the apparatus 100 also includes any number of user interactive devices 20 (hereinafter referred to as “user device” or “user devices”) which can be associated with any number of users, individuals, or viewers, described herein.

In the preferred embodiment, the user device 20 can be an interactive television for enabling the respective user, individual, or viewer (hereinafter referred to as “viewer”), to interact with, participate in, and/or provide control over the presentation of, the program, event, or game, which is being broadcast to and/or provided to, the viewer or listener. In another preferred embodiment, the user device 20 can also be an interactive radio.

The user device(s) 20 can also be any one or more of a computer, a personal computer, a telephone, a wireless telephone, a personal digital assistant, a video telephone, a videophone, a personal communication device, a wireless device, a handheld device, a palm-top device, a watch, a radio, a two-way radio, and/or any other communication device(s) and/or computer(s).

The user device 20 can be directly linked to the central broadcasting system 10, such as in the case of a cable television system, and/or can be linked to the central broadcasting system 10 via a wireless communication network. The user device 20 can also be linked with the central broadcasting system 10 via any other suitable communication network or system.

With reference once again to FIG. 1, the apparatus 100 also includes any number of location broadcasting systems 30 which can be associated with, and/or located at, any program, program venue, event location, event venue, game location, game venue, and/or at any other location from which a broadcast can or may originate. For example, in the case of a television program, a location broadcasting system 30 can be located on the program set or place of filming. In the case of a sporting event, the location broadcasting system 30 can be located at the stadium or arena which is the venue of the sporting event or game.

The location broadcasting system 30 can also be, or can be a component of, a broadcasting system which can include cameras, video recording devices, microphones, audio recording devices, and/or any other devices or systems for facilitating the broadcasting of a live program, event, or game, and/or a pre-recorded program, event, game. For example, on the case of a broadcast of a sporting event, the broadcasting system can include all of the components and/or systems for broadcasting the event as well as the location broadcasting system 30 for facilitating the interactive functionality described herein as being provided by the apparatus 100.

Any number of location broadcasting systems 30 and/or broadcasting systems can be utilized in conjunction with the present invention.

In the preferred embodiment of the present invention, any of the user devices 20 can transmit data and/or information to, and/or receive data and/or information from, any of the central broadcasting systems 10, location broadcasting systems 30, and/or any of the other user devices 20 utilized in conjunction with the apparatus 100.

Any of the central broadcasting systems 10 can transmit data and/or information, as well as broadcast signals, to, and/or receive data and/or information from, any of the user devices 20, location broadcasting systems 30, and/or any of the other central broadcasting systems 10 utilized in conjunction with the apparatus 100. Any of the central location broadcasting systems 30 can transmit data and/or information, as well as broadcast signals, to, and/or receive data and/or information from, any of the central broadcasting systems 10, user devices 20, and/or any of the other location broadcasting systems 30, utilized in conjunction with the apparatus 100.

In the preferred embodiment, the apparatus 100 can be utilized on, over, and/or in conjunction with, a cable television system, or other suitable television broadcasting system, which can facilitate the utilization of interactive televisions and/or any of the other user devices 20 described herein, in an interactive television and/or interactive broadcasting system or environment. The apparatus 100 can also be utilized on, over, and/or in conjunction with a wireless communication network or system.

The apparatus 100 can also be utilized on, over, and/or in conjunction with, any one or more of a telephone network, a telecommunication network, a television broadcasting network, a television network, a power distribution network, a digital communication network, a satellite communication network, a wireless communication network, a personal communication services network, a broadband communication network, a bluetooth communication network, the Internet, the World Wide Web, and/or any other communication network and/or system.

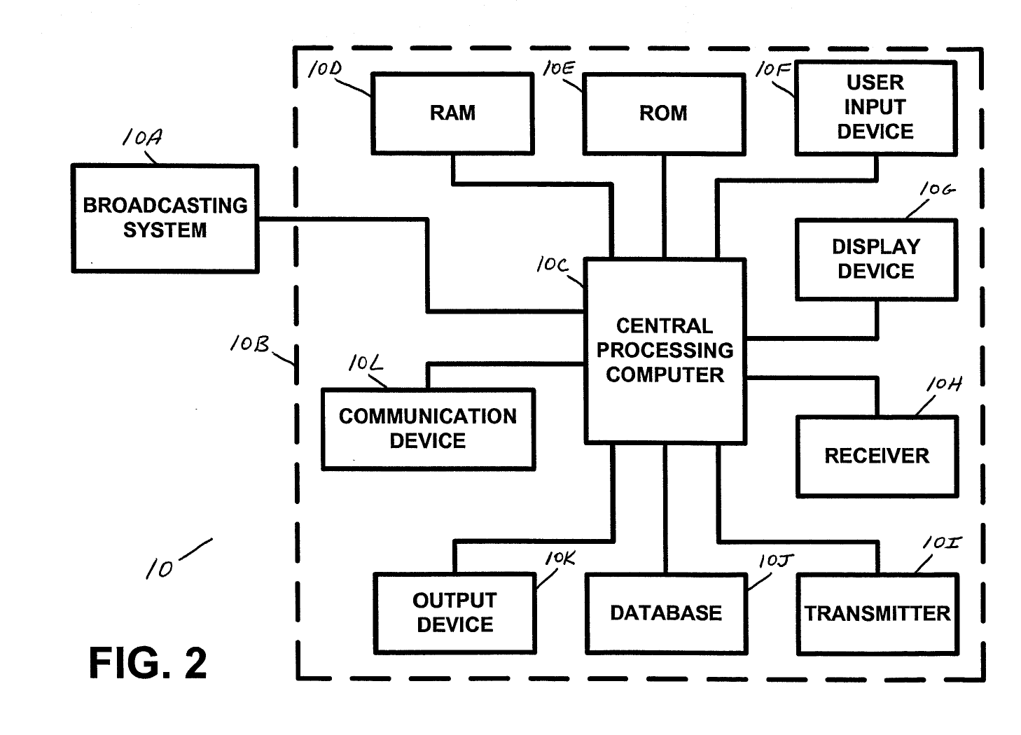

FIG. 2 illustrates the central broadcasting system 10 of FIG. 1, in block diagram form. With reference to FIG. 2, the central broadcasting system 10 includes a broadcasting system 10A which can include any and/or all of the components, computers, systems, cameras, microphones, recording devices, receivers, transmitters, amplifiers, repeaters, and/or any other devices which are normally associated with conventional and/or interactive broadcasting systems, or networks. In the case of cameras, microphones, and/or their respective recording devices, any number of cameras, microphones, or associated recording devices, can be utilized and can be located at any appropriate location in, on, and/or around, a respective venue, stage, set, filming venue, filming stage, filming set, stadium, arena, hall, or other place or location of the program, event, or game.

The cameras and/or microphones can be moveable, pivotable, and/or otherwise controlled or manipulated, by the broadcasting system and/or by any components devices or systems thereof. The camera(s) can also be controlled or manipulated by user or viewer via the user device 20.

The broadcasting system 10A can be a television broadcasting system, a cable television broadcasting system, a satellite television broadcasting system, a digital and/or a high definition television broadcasting system, a radio broadcasting system, and/or any other broadcasting system.

The central broadcasting system 10 can also include a central processing computer 10B for providing control over the central broadcasting system 10 and the broadcasting system 10A. The central processing computer 10B is connected to and/or linked with the broadcasting system 10A. The central processing computer 10B can include a central processing unit 10C, a random access memory device (RAM) 10D, a read only memory (ROM) device 10E, a user input device 10F which can be a keyboard, a touch pad, a keypad, a mouse, a pointing device, an data input device such as a retinal scanner, a finger print reading device, a card reader, a magnetic card reader, and/or any other device for entering data and/or commands into the central processing computer 10B.

The central processing computer 10B can also include a display device 10G, and a receiver 10H for receiving data and/or information from any of the users, individuals, viewers, user devices 20, location broadcasting systems 30, and/or from any other central broadcasting systems 10. The central processing computer 10B can also include a transmitter 10I which can transmit data and/or information to any of the users, individuals, viewers, user devices 20, location broadcasting systems 30, and/or from any other central broadcasting systems 20.

The central processing computer 10B can also include a database 10J which can include any of the data and/or information, as well as software programs and/or algorithms for facilitating the operation of the central broadcasting system 10, the central processing computer 10B, and/or the apparatus 100 as described herein.

For example, the database 10J can contain data and/or information regarding the various programs, events, games, and/or other broadcasts which are provided by the central broadcasting system(s) 10 and/or the location broadcasting system(s) 30 utilized in conjunction with the apparatus 100, data and/or information regarding schedules for programs, events, and/or games, data and/or information regarding the users, individuals, and/or viewers, who or which utilize the apparatus, including but not limited to name, address, telephone number, fax number, e-mail address, account number, interactive account number, individual profile information, individual viewing habit information, individual viewing selections, past viewing and/or interactive behavior, and/or any other information regarding the users, individuals, or viewers.

The database 10J can also contain account information relating to the viewer's interactions with programs, events, or games, gaming accounts, game accounts, and/or financial accounts. The database 10J can also contain e-mail accounts, communication accounts, bulletin board accounts, chat room accounts, etc., for facilitating communication between any of the users, individuals, viewers, broadcasters, participants, players, and/or other individuals or entities who or which utilize the apparatus 100.

The database 10J can also contain any other data and/or information described herein as being processed and/or utilized by the apparatus 100 and/or any of its component systems and/or devices.

The central processing computer 10B can also include an output device 10K which can be a printer, a display device, a modem, a fax/modem, and/or any other device for outputting data and/or information from the central processing computer 10B and/or from the central broadcasting system 10.

The central processing computer 10B can also include a communication device 10L for allowing two-way communication between an individual or participant located at, or participating in, the program, event, or game and a user, individual, or viewer of the respective program, event, and/or game. The communication device 10L can and/or can include a telephone, an internet telephone, a telephone for providing voice over Internet and/or voice over IP.

The communication device 10L can also include, among other things, a video camera for recording video at the central broadcasting system 10 (i.e. a video of an individual) and a microphone for recording audio at the central broadcasting system 10 (i.e. audio of the individual's voice or background sounds), a display device for displaying video of the other party to the communication, and a speaker for providing audio of the other party to the communication. In this manner, the communication device 10L can facilitate two-way video and audio communication between the individual or participant at central broadcasting system and the viewer using the user device 20, and/or any other individuals, users, and/or viewers described herein as well any third parties who or which utilize the present invention.

The communication device 10L can be linked with the central processing computer 10B and/or the broadcasting system 10A via a wireless link and and/or can be connected with the central processing computer 10B and/or the broadcasting system 10A via a wired connection or link.

The video camera and/or the microphone of the communication device 10L can also be located at or on any one of more of any components of the broadcasting system 10A, a telephone, and/or a separate communication device or telephone associated with the central broadcasting system 10, the broadcasting system 10A, and/or the central processing computer 10B, and/or at and/or on any other suitable location or device.

The communication device 10L can provide communications in video form, in audio form, in audio and video form, in text form, and/or in any combination of the above forms. The communication device 10L can provide and/or can facilitate live communication and/or pre-recorded and/or tape delayed communication between any of individuals or participants and any of the users and/or viewers, described herein.

The central broadcasting system 10 can also be utilized as, or function as, a location broadcasting system 30.

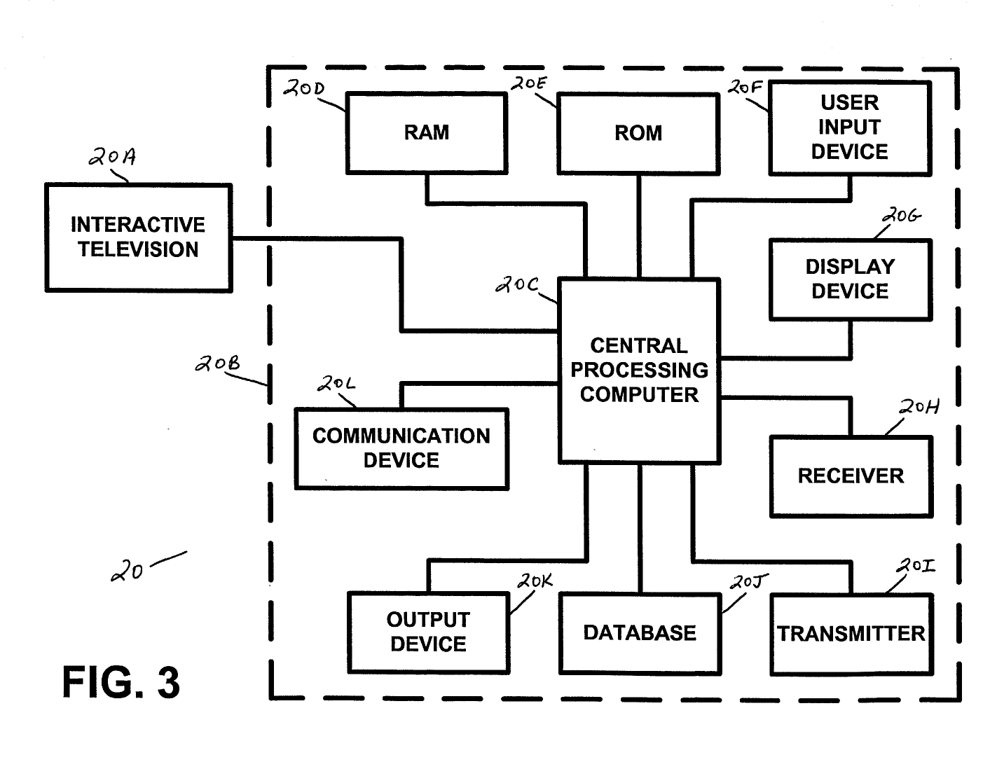

FIG. 3 illustrates the user device 20 if FIG. 1, in block diagram form. In the preferred embodiment of FIG. 3, an interactive television is utilized as the user device 20. While described as being an interactive television, it is to be understood that the user device 20 can be, and/or can include, any one or more of an interactive radio, a computer, a personal computer, a telephone, a wireless telephone, a personal digital assistant, a video telephone, a videophone, a personal communication device, a wireless device, a handheld device, a palm-top device, a watch, a radio, a two-way radio, and/or any other communication device(s) and/or computer(s).

With reference to FIG. 3, the user device 20 includes a television 20A which can be, and/or can include the components and/or systems (i.e. television receiver, speaker(s), television display screen, picture tube, projection device, control panel, antenna and/or cable interface, remote control, etc.) of, a conventional television, a digital television, projection television, a high definition television, and/or any other type of television and/or television system. The television 20A can also include any other components and/or systems for facilitating the operation of the user device 20 as described herein and/or for operating in conjunction with the central broadcasting system(s) 10 or location broadcasting system(s) 30, described herein.

In the case of an interactive radio, a radio can be utilized as the element 20A of the user device 20. In a similar manner, any suitable respective device can be utilized as the element 20A for any of the other user devices 20 which are described herein as being capable of being utilized in conjunction with the present invention.

The user device 20 can also include a central processing computer 20B for providing control over the user device 20 and the television 20A. The central processing computer 20B is connected to and/or linked with the television 20A. The central processing computer 20B can include a central processing unit 20C, a random access memory device (RAM) 20D, a read only memory (ROM) device 20E, a user input device 20F which can be a control panel, a remote control, a keyboard, a touch pad, a keypad, a mouse, a pointing device, a wireless pointing device, an infrared pointing device, laser pointing device, trackball pointing device, a data input device such as a retinal scanner, a finger print reading device, a card reader, a magnetic card reader, and/or any other device for entering data and/or commands into the central processing computer 20B.

The central processing computer 20B can also include a display device 20G. The display device 20G can be any one or more of a display device on a control panel of the central processing computer 20B, a display on the television 20A, a display on the television screen, a display on the remote control device, and/or any other display device, and/or can be any combination of same.

The central processing computer 20B can also include a receiver 20H which can receive data and/or information from any one or more of the central broadcasting systems 10, the central processing computers 10B, the location broadcasting systems 30, the central processing computers 30B, and/or any of the other user devices 20 utilized in conjunction with the present invention. The central processing computer 20B can also include a transmitter 20I which can transmit data and/or information to any one or more of the central broadcasting systems 10, the central processing computers 10B, the location broadcasting systems 30, the central processing computers 30B, and/or any of the other user devices 20 utilized in conjunction with the present invention.

The central processing computer 20B can also include a database 20J which can include any of the data and/or information, as well as software programs and/or algorithms for facilitating the operation of the user device 20, the central processing computer 20B, and/or the apparatus 100 as described herein.

For example, the database 20J can contain data and/or information regarding the various programs, events, games, and/or other broadcasts which are provided by the central broadcasting system(s) 10 and/or the location broadcasting system(s) 30 utilized in conjunction with the apparatus 100, data and/or information regarding schedules for programs, events, and/or games, data and/or information regarding the users, individuals, and/or viewer's who or which utilize the apparatus, including but not limited to name, address, telephone number, fax number, e-mail address, account number, interactive account number, individual profile information, individual viewing habit information, individual viewing selections, past viewing and/or interactive behavior, and/or any other information regarding the users, individuals, or viewers.

The database 20J can also contain account information relating to the viewer's interactions with programs, events, or games, gaming accounts, game accounts, and/or financial accounts. The database 20J can also contain e-mail accounts, communication accounts, bulletin board accounts, chat room accounts, etc., for facilitating communication between any of the users, individuals, viewers, broadcasters, participants, players, and/or other individuals or entities who or which utilize the apparatus 100. The database 20J can also contain any other data and/or information described herein as being processed and/or utilized by the apparatus 100 and/or any of its component systems and/or devices.

The central processing computer 20B can also include an output device 20K which can be a printer, a display device, a speaker, a speaker system, a modem, a fax/modem, and/or any other device for outputting data and/or information, in any appropriate form or format, including but not limited to, video, audio, audio and video, text, and/or any combination of same.

The central processing computer 20B can also include a communication device 20L for allowing two-way communication between and the user or viewer and an individual located at, or participating in, the program, event, or game. The communication device 20L can and/or can include a telephone, an internet telephone, a telephone for providing voice over Internet and/or voice over IP.

The communication device 20L can also include, among other things, a video camera for recording video at the user device 20 (i.e. a video of the viewer) and a microphone for recording audio at the user device 20 (i.e. audio of the viewer's voice or background sounds), a display device for displaying video of the other party to the communication, and a speaker for providing audio of the other party to the communication. In this manner, the communication device 20L can facilitate two-way video and audio communication between the viewer using the user device 20 and individuals and/or participants in the respective program(s), event(s), and/or game(s), and/or any other individuals, users, and/or viewers described herein as well any third parties who or which utilize the present invention.

The communication device 20L can be linked with the central processing computer 20P and/or the television 20A via a wireless link and and/or can be connected with the central processing computer 20B and/or the television 20A via a wired connection or link. The video camera and/or the microphone of the communication device 20L can also be located at or on any one of more of the television 20A, on the control panel of the television, on the central processing computer 20B, on the remote control device, a telephone, a separate communication device or telephone associated with the user device 20, the television 20A, and/or the central processing computer 20B, and/or at and/or on any other suitable location or device.

The communication device 20L can provide communications in video form, in audio form, in audio and video form, in text form, and/or in any combination of the above forms. The communication device 20L can provide and/or can facilitate live communication and/or pre-recorded and/or tape delayed communication between any of the users, viewers, individuals, and/or participants, described herein.

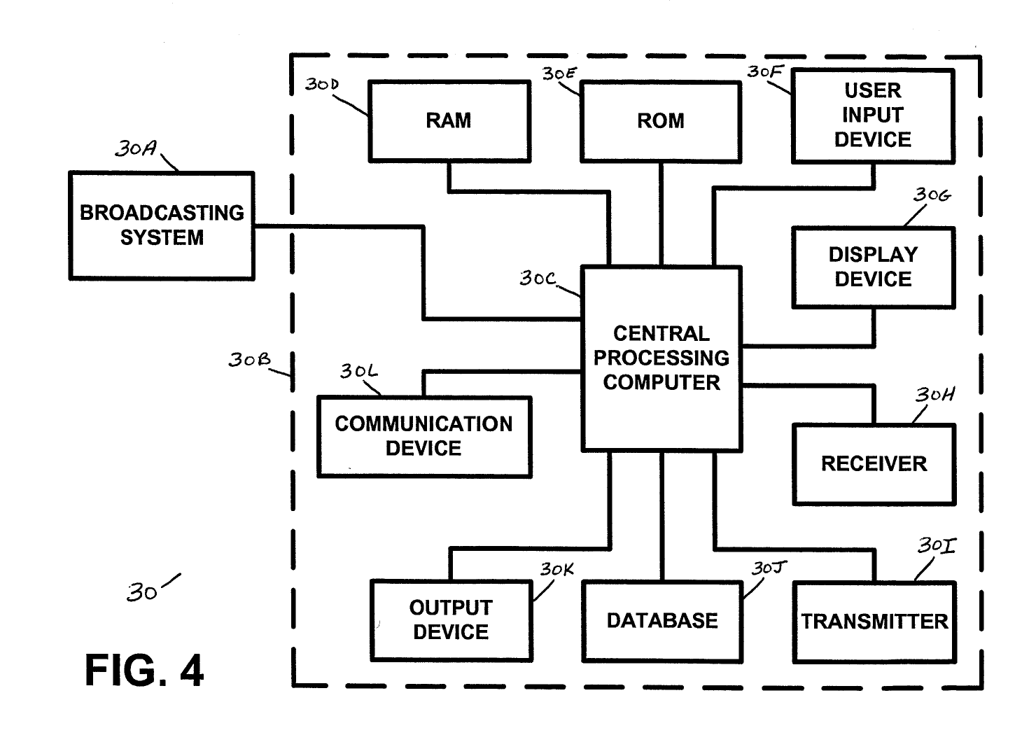

FIG. 4 illustrates the location broadcasting system 30 of FIG. 1, in block diagram form. With reference to FIG. 4, the location broadcasting system 30 includes a broadcasting system 30A which can include any and/or all of the components, computers, systems, cameras, microphones, recording devices, receivers, transmitters, amplifiers, repeaters, and/or any other devices which are normally associated with conventional and/or interactive broadcasting systems, or networks.

In the case of cameras, microphones, and/or their respective recording devices, any number of cameras, microphones, or associated recording devices, can be utilized and can be located at any appropriate location in, on, and/or around, a respective location venue, stage, set, filming venue, filming stage, filming set, stadium, arena, hall, or other place or location of the program, event, or game. For example, television cameras can be set up all around the a sports stadium so as to afford views of a sporting event or game from any desired angle.

The cameras and/or microphones can be moveable, pivotable, and/or otherwise controlled or manipulated, by the broadcasting system and/or by any components devices or systems thereof. The camera(s) can also be controlled or manipulated by user or viewer via the user device 20.

The broadcasting system 30A can be a television broadcasting system, a cable television broadcasting system, a satellite television broadcasting system, a digital and/or a high definition television broadcasting system, a radio broadcasting system, and/or any other broadcasting system, or component system thereof.

The location broadcasting system 30 can also include a central processing computer 30B for providing control over the location broadcasting system 30 and the broadcasting system 30A. The central processing computer 30B is connected to and/or linked with the broadcasting system 30A. The central processing computer 30B can include a central processing unit 30C, a random access memory device (RAM) 30D, a read only memory (ROM) device 30E, a user input device 30F which can be a keyboard, a touch pad, a keypad, a mouse, a pointing device, an data input device such as a retinal scanner, a finger print reading device, a card reader, a magnetic card reader, and/or any other device for entering data and/or commands into the central processing computer 30B.

The central processing computer 30B can also include a display device 30G, and a receiver 30H for receiving data and/or information from any of the users, individuals, viewers, user devices 20, central broadcasting systems 10, and/or from any of the other location broadcasting systems 30. The central processing computer 30B can also include a transmitter 30I which can transmit data and/or information to any of the users, individuals, viewers, user devices 20, central broadcasting systems 10, and/or from any other location broadcasting systems 30.

The central processing computer 30B can also include a database 30J which can include any of the data and/or information, as well as software programs and/or algorithms for facilitating the operation of the location broadcasting system 30, the central processing computer 30B, and/or the apparatus 100, as described herein. For example, the database 30J can contain data and/or information regarding the various programs, events, games, and/or other broadcasts which are provided by the central broadcasting system(s) 10 and/or the location broadcasting system(s) 30 utilized in conjunction with the apparatus 100, data and/or information regarding schedules for programs, events, and/or games, data and/or information regarding the users, individuals, and/or viewer's who or which utilize the apparatus, including but not limited to name, address, telephone number, fax number, e-mail address, account number, interactive account number, individual profile information, individual viewing habit information, individual viewing selections, past viewing and/or interactive behavior, and/or any other information regarding the users, individuals, or viewers.

The database 30J can also contain account information relating to the viewer's interactions with programs, events, or games, gaming accounts, game accounts, and/or financial accounts. The database 30J can also contain e-mail accounts, communication accounts, bulletin board accounts, chat room accounts, etc., for facilitating communication between any of the users, individuals, viewers, broadcasters, participants, players, and/or other individuals or entities who or which utilize the apparatus 100. The database 30J can also contain any other data and/or information described herein as being processed and/or utilized by the apparatus 100 and/or any of its component systems and/or devices.

The central processing computer 30B can also include an output device 30K which can be a printer, a display device, a modem, a fax/modem, and/or any other device for outputting data and/or information from the central processing computer 30B and/or from the central broadcasting system 10.

The central processing computer 30B can also include a communication device 30L for allowing two-way communication between an individual or participant located at, or participating in, the program, event, or game and a user, individual, or viewer of the respective program, event, and/or game. The communication device 30L can and/or can include a telephone, an Internet telephone, a telephone for providing voice over Internet and/or voice over IP.

The communication device 30L can also include, among other things, a video camera for recording video at the location broadcasting system 30 (i.e. a video of an individual) and a microphone for recording audio at the location broadcasting system 30 (i.e. audio of the individual's voice or background sounds), a display device for displaying video of the other party to the communication, and a speaker for providing audio of the other party to the communication. In this manner, the communication device 30L can facilitate two-way video and audio communication between the individual or participant at location broadcasting system and the viewer using the user device 20, and/or any other individuals, users, and/or viewers described herein as well any third parties who or which utilize the present invention.

The communication device 30L can be linked with the central processing computer 30B and/or the broadcasting system 30A via a wireless link and and/or can be connected with the central processing computer 30B and/or the broadcasting system 30A via a wired connection or link. The video camera and/or the microphone of the communication device 30L can also be located at or on any one of more of any components of the broadcasting system 30A, a telephone, and/or a separate communication device or telephone associated with the location broadcasting system 30, the broadcasting system 30A, and/or the central processing computer 30B, and/or at and/or on any other suitable location or device.

The communication device 30L can provide communications in video form, in audio form, in audio and video form, in text form, and/or in any combination of the above forms. The communication device 30L can provide and/or can facilitate live communication and/or pre-recorded and/or tape delayed communication between any of individuals or participants and any of the users and/or viewers, described herein.

The location broadcasting system 30 can also be utilized as, or function as, a central broadcasting system 10.

The apparatus and method of the present invention can be utilized in many preferred embodiments. In a preferred embodiment, the apparatus and method of the present invention can be utilized in order to facilitate viewer or listener interaction with a program, programs, an event, events, a game, games, a sporting event, sporting events, a television program, television programs, a television show, television shows, a television game show, television game shows, a movie, movies, a radio program, radio programs, a marketing program, marketing programs, an infomercial, infomercials, marketing information, a commercial, and/or commercials.

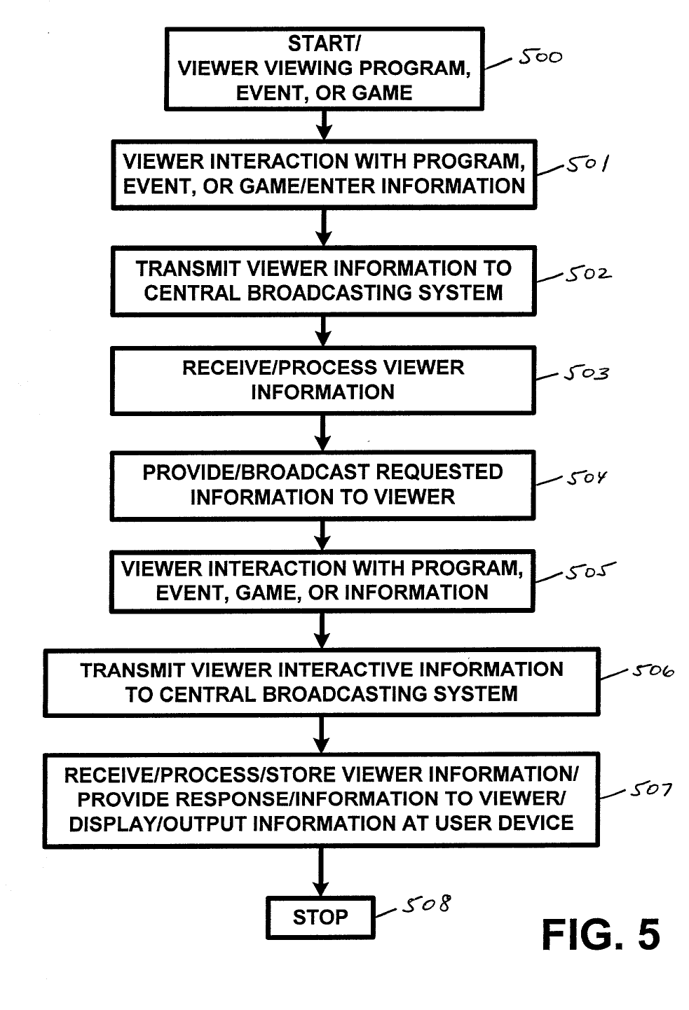

FIG. 5 illustrates a preferred embodiment method for utilizing the apparatus 100, in flow diagram form. With reference to FIG. 5, the operation of the apparatus 100 commences at step 500 with the user's or the viewer's viewing of, or deciding to view, a television program, event, or game, on the user device 20. In the case of a radio program, event, or game, the operation of the apparatus 100 can commence with the user's listening, or deciding to listen, to the radio program, event, or game, on the user device 20.

At step 500, the television program, event, or game, can also be a commercial, an advertisement, and/or marketing information, which is being provided to and/or on the user device 20. The broadcaster of the respective program, event, game, commercial, an advertisement, and/or marketing information, can be any broadcaster or media provider. The respective program, event, game, commercial, an advertisement, and/or marketing information, can be broadcast from the central broadcasting system 10 and/or the location broadcasting system 30.

At step 501, the viewer can interact with the broadcaster of the of the program, event, game, commercial, advertisement, and/or marketing information, by entering information in the form of a request for information, a response to a query or question provided by the respective broadcaster, central broadcaster, location broadcaster, and/or enter information in any other form. For example, at step 501, the viewer can request that the broadcaster provide the respective program, event, or game, commercial, advertisement, and/or marketing information, to the viewer in any one or more of in color, in black and white, in three dimensional (3D) form, in high definition format, in stereo sound, and/or in any other broadcasting or presentation form or format.

The viewer can interact with the broadcaster of the program, event, game, commercial, advertisement, and/or marketing information, by any one or more of voice conversation, telephone conversation, videophone conversation, audio and video telephone conversation, Internet telephony conversation, speaking directly with an individual, text messaging, instant messaging, e-mail message, facsimile messaging, and/or via a other appropriate manners or techniques, and/or via any combination of same.

The viewer, at step 501, can also enter a request for schedules of any of the respective programs, events, games, commercials, advertisements, and/or marketing information, and/or a request for information, including, but not limited to descriptions of, actors, players, teams, participants, directors, producers, related information, and/or any other information, pertaining to and/or relating to any of the respective programs, events, games, commercials, advertisements, and/or marketing information. For example, a viewer can request a short description of a respective program, event, game, commercial, advertisement, and/or marketing information (i.e. actors involved, event description, game participants, viewer participation in a game or game show, commercial type, compensation paid for the commercial, etc.).

At step 501, the viewer can also request information on any goods, products, and/or services, which he or she is interested in purchasing, order, or leasing. The information can be in the form of requested commercials, advertisements, marketing information, and/or infomercials, which may or which may not facilitate viewer interactivity.

At step 501, the viewer can also enter a request to receive a respective program, event, game, commercial, advertisement, and/or marketing information, on demand. In the case of commercials, advertisements, and/or marketing information, which seek to obtain viewer responses and/or participation, a viewer can request information regarding the respective commercials, advertisements, and/or marketing information, along with information concerning the compensation, if any, paid of provided to the viewer for the viewer's participation in same.

At step 501, the viewer can also request to participate in the respective commercials, advertisements, and/or marketing information. At step 501, the viewer can also request to receive certain types of, and/or specific commercials, advertisements, and/or marketing information, during commercial breaks in a program, event, game, commercial, advertisement, and/or marketing information. The viewer can also request a program, event, game, commercial, advertisement, and/or marketing information, to be provided with commercial interruption.

At step 501, the viewer can also enter any other information and/or requests which can be related to the interactive use of the apparatus 100 of the present invention.

At step 502, the viewer's entered information or request is transmitted to the respective central broadcasting system 10, or to the appropriate location broadcasting system 30. At step 503, the entered information or request is received and processed by the central broadcasting system 10 and/or by the central processing computer 10B. In the case transmission to the location broadcasting system 30, the entered information or request is received and processed by the location broadcasting system 30 and/or by the central processing computer 30B.

At step 504, the central broadcasting system 10 will provide the viewer with the requested program, event, game, commercial, advertisement, and/or marketing information, in the requested form or format and/or in any other requested manner, if appropriate.

At step 505, the viewer can view, and/or interact with, if appropriate, the respective program, event, game, commercial, advertisement, and/or marketing information, and interact with same, if appropriate and/or if desired. For example, in the case of a commercial, an advertisement, marketing information, a program, an event, and/or a game, which allows or requests viewer or listener involvement, viewer or listener interaction, and/or viewer or listener responses, of any kind, the viewer or listener can interact with the event, enter responses to surveys, commercials, advertisements, marketing information, enter information or comments relating to programs, events, and/or games, and/or in any other way interact with and/or provide information to the respective broadcasters, media providers, and/or producers, disseminators and/or sponsors, of any respective program, event, game, commercial, advertisement, and/or marketing information.

At step 505, the viewer can also enter into transactions to purchase, lease, or place an order for, any goods, products, and/or services, which can be seen in and/or which can be featured in any of the programs, events, games, commercials, advertisements, marketing information, and/or infomercials.

At step 506, the viewer interactive information and/or responses can be transmitted to the central broadcasting system 10. In the case of interaction with a location broadcasting system 30, the viewer interactive information and/or responses can be transmitted to the location broadcasting system 30. At step 507, the respective central broadcasting system 10, central processing computer 10B, location broadcasting system 30, and/or central processing computer 30B, can receive and process the viewer entered information and/or responses.

At step 507, the respective central broadcasting system 10, central processing computer 10B, location broadcasting system 30, and/or central processing computer 30B, can store the information received from the viewer and/or can store information derived from the viewer enter information and/or responses. In instances when the viewer's interaction calls for a response, the providing of additional information, the providing of a service, and/or the providing of compensation, to the viewer, the respective central broadcasting system 10, central processing computer 10B, location broadcasting system 30, and/or central processing computer 30B, will, at step 507, provide the respective response, additional information, service, and/or compensation, to the viewer, to the viewer's user device 20, and/or to an account, financial or otherwise, which is associated with the viewer.

In instances when the viewer purchases, leases, or orders, goods, products, and/or services, the respective central processing computer 10B and/or at the central processing computer 30B, can process the purchases, orders, and/or related transactions and facilitate the transactions between the viewer and the provider or seller of the respective goods, products, and/or services. At step 507, the respective central processing computer 10B and/or at the central processing computer 30B, can provide an appropriate order confirmation and/or transaction report to the user device 20.

The viewer or listener interaction information and/or responses can be stored at the respective central processing computer 10B, and/or in the database 10J, and/or at the central processing computer 30B, and/or in the database 30J, for later use by any of the herein-described broadcasters, media providers, and/or producers, disseminators and/or sponsors, of any respective program, event, game, commercial, advertisement, and/or marketing information.

At step 507, any of the herein-described information provided by the respective central processing computer 10B and/or at the central processing computer 30B, to the user device can be output in hard copy form from the output device 20K such as from a printer, and/or stored in electronic form in the database 20J.

Steps 505 through 507 can be repeated throughout the duration of the presentation of the respective program, event, game, commercial, advertisement, and/or marketing information.

Thereafter, the operation of the apparatus 100 will cease at step 508.

The embodiment of FIG. 5 can be utilized in order to allow the viewer to request certain programs, events, games, commercials, advertisements, and/or marketing information, which the viewer desires to view and/or to interact with, to allow the viewer to request or select the form of presentation of the respective program, event, game, commercial, advertisement, and/or marketing information, and/or to allow the viewer to interact with, to enter information, and/or to respond to information, provided by, and/or found or featured in, the respective program, event, game, commercial, advertisement, and/or marketing information.

In another preferred embodiment of the embodiment of FIG. 5, the information which is stored, at step 507, in the respective central processing computer 10B, and/or in the database 10J, and/or at the central processing computer 30B, and/or in the database 30J, can be utilized by any of the herein-described broadcasters, media providers, and/or producers, disseminators and/or sponsors, of any respective program, event, game, commercial, advertisement, and/or marketing information, and/or advertisers or marketers, in order to perform targeted advertisement and/or marketing campaigns to certain viewers.

In another preferred embodiment of the embodiment of FIG. 5, the information which is stored, at step 507, in the respective central processing computer 10B, and/or in the database 10J, and/or at the central processing computer 30B, and/or in the database 30J, can be utilized to perform market research activities and/or to gather market research data and/or information. The apparatus 100 of FIG. 5 can also be utilized in order to conduct market research activities, test marketing activities, and/or focus group activities.

In another preferred embodiment, the apparatus 100 can be utilized in order to provide for a compensation-based viewer or listener interaction. In this embodiment, the viewer can be compensated and/or otherwise paid for his or her interactivity and/or participation in programs, events, games, commercials, advertisements, surveys, and/or marketing activities, provided to the viewer. In this regard, a producer of a television program or movie can ascertain which actors or types of stories the viewer or viewers enjoy or desire to see, which types of events or which event performers the viewer or viewers desire to see, which types of games and which types of compensation the viewer or viewers desire to see played and/or provided to participants and/or to participating viewers, which types of advertisements, commercials, and/or marketing information a viewer or viewers desires or desire to view and/or participate in, and/or any other information which any of the broadcasters, media providers, and/or producers, disseminators and/or sponsors, of any respective program, event, game, commercial, advertisement, and/or marketing information, and/or advertisers or marketers, may be interested in obtaining from an interactive viewer or viewers.

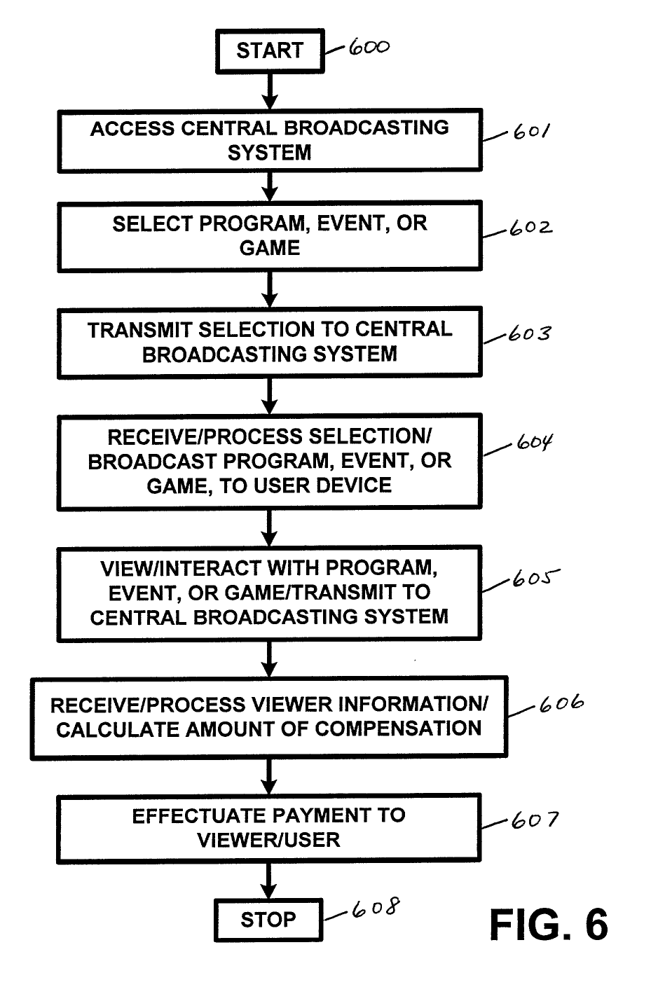

FIG. 6 illustrates another preferred method for utilizing the apparatus 100 of the present invention. With reference to FIG. 6, the operation of the apparatus 100 commences at step 600. At step 601, the viewer can access the central broadcasting system 10 via the user device 20.

At step 602, the viewer can select the program(s), event(s), game(s), advertisement(s), commercial(s), and/or marketing information, which the viewer desires to view and/or interact with. The viewer can select the respective program(s), event(s), game(s), advertisement(s), commercial(s), and/or marketing information, from a menu(s) or listing(s) which identifies the respective program(s), event(s), game(s), advertisements(s), commercial(s), and/or marketing information, the schedule(s) of broadcasting of the respective program(s), event(s), game(s), advertisement(s), commercial(s), and/or marketing information, along with the amount and type of compensation offered for viewing and interacting with same.

For example, a program producer can provide a program to a viewer and ask the viewer for story suggestions any time or times throughout the playing of the program. The program producer can offer compensation to a viewer for providing information or suggestions via the user device 20 to the central broadcasting system 10, at any time during, prior to, and/or subsequent to, the playing of the program, television show, movie, and/or other program, which may assist the program producer in obtaining ideas for new or later program stories and/or story lines and/or for getting an indication of which subject matter in which a viewer or group of viewers may be interested.

Similarly, an event promoter can obtain valuable information concerning the types, or subject matter, of events in which a viewer or group of viewers may be interested. In a similar manner, a team owner can obtain information from viewing fans regarding which players the viewer or group of viewers desire to see play and/or the types of plays which they desire to see be executed.

Providers of goods, products, and/or services, advertisers, marketers, and sponsors, can also obtain information and/or feedback regarding advertisements, commercials, marketing campaigns, and/or prior experience and/or degrees of satisfaction and/or dissatisfaction with any of the respective goods, products, and/or services.

At step 602, the viewer can make a selection or the selections of any number of kinds and/or types of program(s), event(s), game(s), advertisement(s), commercial(s), and/or marketing information.

At step 603, the viewer's selections) can be transmitted to the central broadcasting system 10. At step 604, the central broadcasting system 10 and/or the central processing computer 10B can receive and process the viewer's selection(s).

At step 604, the central broadcasting system 10 can provide the selected program(s), event(s), game(s), advertisements), commercials), and/or marketing information, to the viewer's user device 20, one at a time and in any order picked by the viewer, the central broadcasting system 10, and/or selected randomly by the central processing computer 10B.

At step 605, the viewer will view the respective program(s), event(s), game(s), advertisement(s), commercial(s), and/or marketing information, and interact with same by any one or more of providing answers to specific questions, by providing answers to general questions, by responding to specific prompts or requests for viewer feedback, and/or by making suggestions and/or comments regarding the respective program(s), event(s), game(s), advertisement(s), commercial(s), and/or marketing information.

At step 605, the viewer's replies, responses, comments, and/or suggestions, can be transmitted to the central broadcasting system 10 in real-time and/or all at once upon the completion of the broadcast of the respective program(s), event(s), game(s), advertisement(s), commercial(s), and/or marketing information.

At step 606, the central broadcasting system 10 and/or the central processing computer 10B can receive and process the viewer's replies, responses, comments, and/or suggestions. At step 606 the central processing computer 10B can store the viewer's replies, responses, comments, and/or suggestions, as well as any information derived therefrom. At step 606, the central processing computer 10B can also calculate the amount of compensation earned by the viewer.

At step 607, the central processing computer 10B can effectuate payment of the compensation to a financial account associated with the viewer and transmit a message to the user device 20 in order to provide notification to the viewer of the compensation which the viewer earned for his or her participation in the respective program(s), event(s), game(s), advertisement(s), commercial(s), and/or marketing information.

In the preferred embodiment, the central processing computer 10B can manage and/or administer financial accounts for any of the herein-described viewers, broadcasters, media providers, and/or producers, disseminators and/or sponsors, of any respective program, event, game, commercial, advertisement, and/or marketing information, and/or advertisers or marketers.

The central processing computer can make payments of compensation from any of the accounts associated with any of the broadcasters, media providers, and/or producers, disseminators and/or sponsors, of any respective program, event, game, commercial, advertisement, and/or marketing information, and/or advertisers or marketers, to any of the accounts associated with the viewer or viewers.

Any of the information obtained and/or processed at or during steps 605 and 606 can be stored in the database 10J of the central processing computer for later use by any of the herein-described broadcasters, media providers, and/or producers, disseminators and/or sponsors, of any respective program, event, game, commercial, advertisement, and/or marketing information, and/or advertisers or marketers, and/or for later use in market research activities.

Steps 604 through 607 can be repeated for each of the program(s), event(s), game(s), advertisement(s), commercials(s), and/or marketing information, selected by the viewer.

Thereafter, the operation of the apparatus 100 will cease at step 608.

The apparatus 100 of FIG. 6 can also be utilized in conjunction with providing compensation-based viewer interactivity and/or participation with television programs, events, games, advertisements, commercials, and/or marketing information, via an interactive television, a computer, a telephone, a videophone, a radio, an interactive radio, a personal communication device, and/or a personal digital assistant, as well providing compensation-based listener interactivity and/or participation with radio programs, events, games, advertisements, commercials, and/or marketing information, via a radio, an interactive radio, an interactive television, a computer, a telephone, a videophone, a personal communication device, and/or a personal digital assistant.

In the above-described manner, the apparatus 100 can be utilized in order to provide compensation-based viewer or listener interactivity and/or participation with any type of programs, events, games, advertisements, commercials, and/or marketing information. The information obtained from the operation of the embodiment of FIG. 6 can also be utilized in order to conduct targeted advertising and/or marketing campaigns and/or activities.

In another preferred embodiment, the apparatus 100 of the present invention can be utilized in order to enable a viewer to participate in a program, event, and/or game. In this preferred embodiment, the viewer can participate in a program, television show, news broadcast, event, performance, television game show, game show, radio game show, game, contest, and/or sporting event.

The viewer can communicate with actors, hosts, directors, newscasters, broadcasters, event performers, performers, game contestants, game players, athletes, professional sports athletes, professional sports players, amateur sports athletes, amateur sports players, and/or any other individual participating in and/or located at the respective set, studio, performance hall, event venue, stadium, arena, and/or other venue. For example, in the case of a program, a viewer can communicate with the participants (i.e. talk show host, talk show guest, reporter, etc.) and/or the viewer can be a member of the live studio audience. In the case of a television game show, a viewer or viewers can communicate with and/or assist a game show contestant (i.e. assist them in answering game questions, etc.), and/or the viewer or viewers can share in game show prizes along with the contestants.

In the case of a sporting event (i.e. baseball game, football game, basketball game, hockey game, and/or any other sporting event, etc.), the viewer or viewers can communicate with a player, players, coaches, team benches, team dugouts, broadcasters, and/or other individuals participating in the sporting event and/or participating in the broadcast of same.

In the case of television game shows and/or radio game shows, it is envisioned that any one or more of the broadcasters, media providers, and/or producers, disseminators and/or sponsors, of any respective program, event, game, commercial, advertisement, and/or marketing information, and/or advertisers or marketers, can contribute and/or donate prizes and/or prize moneys, which can be shared and/or split, in any appropriate manner, between a game show's contestant(s) and the viewer or viewers who are assisting and/or who are aligned with the contestant(s).

It is envisioned that the participation of viewers in game show's viewing audience, and hence the opportunity to draw a larger viewing audience, can be an incentive for broadcasters, media providers, and/or producers, disseminators and/or sponsors, of any respective program, event, game, commercial, advertisement, and/or marketing information, and/or advertisers or marketers, to contribute prizes and/or moneys, or increased amounts of same. In a similar manner, the opportunity for members of the viewing audience to win prizes or money can be an incentive for viewers to view, listen to, and/or participate in the game show.

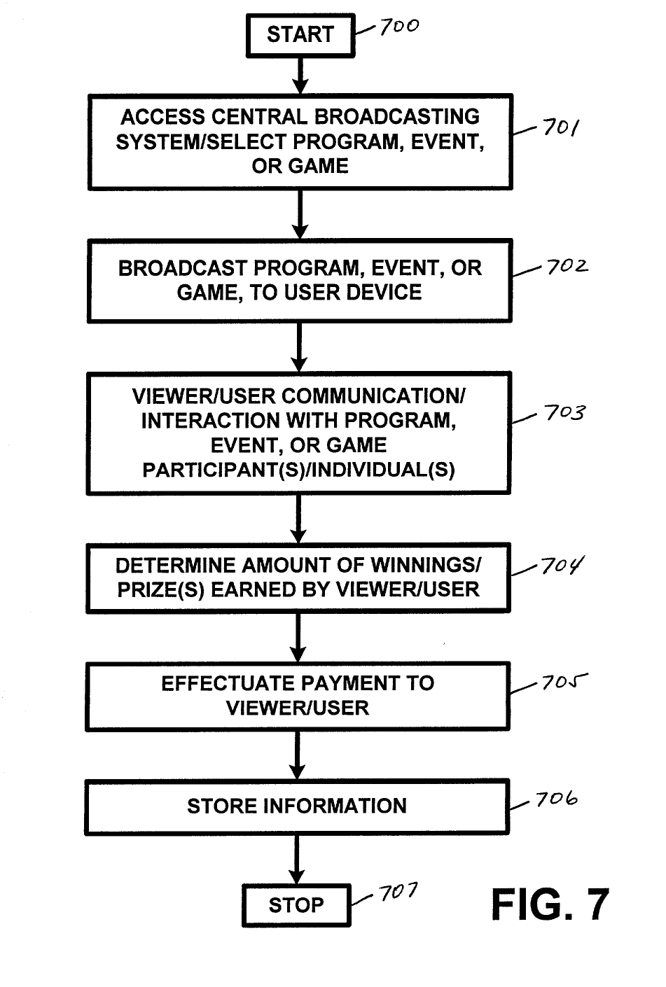

FIG. 7 illustrates another preferred embodiment method for utilizing the apparatus 100 of the present invention, in flow diagram form. With reference to FIG. 7, the operation of the apparatus 100 commences at step 700. At step 701, the viewer can access the central broadcasting system 10 and select the respective program, television show, news broadcast, event, performance, television game show, game show, game, contest, and/or sporting event, which he or she desires to view. In the case of a radio listener, the listener can select the radio program, event, game, or game show, which he or she desires to listen to.

At step 702, the central broadcasting system 10 can commence broadcasting the respective program, television show, news broadcast, event, performance, television game show, game show, game, contest, and/or sporting event, to the viewer's user device 20.

At step 703, at any time during, prior to, and/or subsequent to, the broadcast, the respective viewer or listener can communicate with a with a respective actor, host, director, newscaster, broadcaster, event performer, performer, game contestant, game player, athlete, professional sports athlete, professional sports player, amateur sports athlete, amateur sports player, and/or any other individual, participating in and/or located at the respective set, studio, performance hall, event venue, stadium, arena, and/or other venue, of the respective program, television show, news broadcast, event, performance, television game show, game show, game, contest, and/or sporting event.

The viewer can communicate with, converse with, and/or transmit messages to, a respective actor, host, director, newscaster, broadcaster, event performer, performer, game contestant, game player, athlete, professional sports athlete, professional sports player, amateur sports athlete, amateur sports player, and/or any other individual, by any one or more of voice conversation, telephone conversation, videophone conversation, audio and video telephone conversation, Internet telephony conversation, speaking directly with an individual, text messaging, instant messaging, e-mail message, facsimile messaging, and/or via a other appropriate manners or techniques, and/or via any combination of same.

For example, in the case of a program, a viewer can communicate with the participants (i.e. talk show host, talk show guest, reporter, etc.) and/or the viewer can be a member of the live studio audience. In the case of a television game show, a viewer or viewers can communicate with and/or assist a game show contestant (i.e. assist them in answering game questions, etc.), and/or the viewer or viewers can share in game show prizes along with the contestants.

In the case of a sporting event (i.e. baseball game, football game, basketball game, hockey game, and/or any other sporting event, etc.), the viewer or viewers can communicate with a player, players, coaches, team benches, team dugouts, broadcasters, and/or other individuals participating in the sporting event and/or participating in the broadcast of same.

The viewer or listener can communicate with the respective actor, host, director, newscaster, broadcaster, event performer, performer, game contestant, game player, athlete, professional sports athlete, professional sports player, amateur sports athlete, amateur sports player, and/or any other individual, via the communication device 20L associated with the viewer's user device 20 and the respective communication device(s) 10L and/or 30L associated with the respective central broadcasting system 10 and/or location broadcasting system 30.

The respective communication devices 10L, 20L, and/or 30L can be and/or can include a telephone, video cameras, microphones, speakerphones, videophones and/or any other devices, or combination of devices for facilitating a voice communication, a video communication, and/or a voice and video communication, involving the viewer and the respective actor, host, director, newscaster, broadcaster, event performer, performer, game contestant, game player, athlete, professional sports athlete, professional sports player, amateur sports athlete, amateur sports player, and/or any other individual.

In the case of a program, a viewer can talk with, converse with, speak to, and/or interact with, participants of same (i.e. talk show host, talk show guest, reporter, etc.). The viewer can also be a participating member of the live studio audience.

In the case of a television game show, the viewer can talk with and/or assist a game show contestant (i.e. assist them in answering game questions, etc.). The viewer or a group of individual viewers can provide assistance to and/or consultation to the contestant regarding game show question and/or game show playing strategy.

The viewer can communicate with, converse with, speak to, and/or transmit messages to, the game show contestant by any one or more of voice conversation, telephone conversation, videophone conversation, audio and video telephone conversation, Internet telephony conversation, speaking directly with an individual, text messaging, instant messaging, e-mail message, facsimile messaging, and/or via a other appropriate manners or techniques, and/or via any combination of same.

The viewer can share in game show prizes along with the contestant. The contestant and the viewer or viewers can agree to share prizes and and/or prize money as a team. The sharing percentages can be dictated by the game producers and/or sponsors and/or can be agreed to by the contestant and the viewer or viewers.

As described above, it is envisioned that any one or more of the broadcasters, media providers, and/or producers, disseminators and/or sponsors, of any respective program, event, game, commercial, advertisement, and/or marketing information, and/or advertisers or marketers, can contribute and/or donate prizes and/or prize moneys, which can be shared and/or split, in any appropriate manner, between a game show's contestant(s) and the viewer or viewers who are assisting, providing consultation to, and/or who are aligned with, the contestant(s).

In another preferred embodiment, the viewer can be an actual contestant in a game show in his or her own right by playing the game via his or her user device 20. In this manner, the apparatus 100 can facilitate the remote playing in a game by a viewer or by any number of viewers.

In the case of a sporting event (i.e. baseball game, football game, basketball game, hockey game, and/or any other sporting event, etc.), the viewer or viewers can talk with, interact with, and/or monitor, a respective player, players, coaches, teams, team benches, team dugouts, broadcasters, and/or other individuals participating in the sporting event and/or participating in the broadcast of same. For example, the viewer can discuss the game with a player, coach, or other individual involved in the game and/or in the broadcast of the game.

It is envisioned that any one or more of the broadcasters, media providers, and/or producers, disseminators and/or sponsors, of any respective program, event, game, commercial, advertisement, and/or marketing information, and/or advertisers or marketers, can pay the respective players, coaches, teams, broadcasters, and/or other individuals, and/or contribute and/or donate money and/or other goods, products, and/or services, to the respective players, coaches, teams, broadcasters, and/or other individuals, and/or to their charities, in exchange for their participation in communications with, and/or activities involving, the viewer or viewers.

In a similar manner, it is also envisioned any one or more of the broadcasters, media providers, and/or producers, disseminators and/or sponsors, of any respective program, event, game, commercial, advertisement, and/or marketing information, and/or advertisers or marketers, can pay the actor, host, director, newscaster, broadcaster, event performer, performer, game contestant, and/or other individual, and/or contribute and/or donate money and/or other goods, products, and/or services, to the respective actor, host, director, newscaster, broadcaster, event performer, performer, game contestant, and/or other individual, and/or to their charities, in exchange for their participation in communications with, and/or activities involving, the viewer or viewers.

At step 704, the central processing computer 10B and/or the central processing computer 30B can determine the amount(s) or prizes and/or winnings earned or won by the viewer, at step 703, and/or the central processing computer 10B and/or the central processing computer 30B can determine the amount(s) or money earned by the respective actors, hosts, directors, newscasters, broadcasters, event performers, performers, game contestants, players, coaches, teams, broadcasters, and/or other individuals, and/or their charities, for the respective actors, hosts, directors, newscasters, broadcasters, event performers, performers, game contestants, players, coaches, teams, broadcasters, and/or other individuals participation in communications with the viewer or viewers at step 703.

At step 705, the respective central processing computer 10B and/or the central processing computer 30B can effectuate payment of amounts due to financial accounts associated with the respective viewer(s), actor(s), host(s), director(s), newscaster(s), broadcaster(s), event performer(s), performer(s), game contestant(s), player(s), coaches, team(s), and/or other individuals, and/or their charities, from the financial accounts of the respective broadcasters, media providers, and/or producers, disseminators and/or sponsors, of any respective program, event, game, commercial, advertisement, and/or marketing information, and/or advertisers or marketers.

At step 706, any information concerning any of the communications, interactions, and/or activities, occurring during steps 702 through 705 can, including compensation earned by any of the herein-described respective viewers, actor(s), host(s), director(s), newscaster(s), broadcaster(s), event performer(s), performer(s), game contestant(s), player(s), coaches, team(s), and/or other individuals, can be stored in the respective databases 10J and/or 30J, for use subsequent activities and/or in market research.

Thereafter, the operation of the apparatus 100 will cease at step 707.

In another preferred embodiment, the apparatus 100 can be utilized in order to allow viewers, listeners, and/or spectators, to participate in, to engage in, and/or to play in, game strategy games and/or to engage in game strategy contests or exercises, for recreational purposes, for training purposes, and/or for any other purpose or purposes. It is envisioned that viewers, listeners, or spectator, can try to anticipate the plays or play strategies of the team(s) or player(s) participating in a game or sporting event.

For example, in the case of a baseball game, a viewer, listener, or spectator, can try to anticipate a play, which can include, but which is not limited to, a next pitch thrown in a baseball game (i.e. fastball, slider, curve ball, pitch out, intentional walk, etc.), a batter's hitting instructions, a batter's actions (i.e. take a pitch, hit-and-run, etc.), a base runners actions (i.e. hold the base, steal a base, hit-and-run), defensive players positioning and/or fielding strategies, and/or any other player actions and/or plays which can be performed and/or made by a team(s) and/or a player(s) on both the batting team and/or the fielding team.

In the case of a football game, a viewer, listener, or spectator, can try to anticipate a play, which can include, but which is not limited to, offensive plays, such as, but not limited to, a rushing play, a run, a pass, a punt, a field goal, defensive plays, such as, but not limited to, covering certain players, blitzes, and/or any other defensive plays, etc., and/or any type(s), kind(s), and/or variation(s) of any plays which can be made or performed by a team(s) and/or player(s) in a football game.

The apparatus 100 can also be utilized in conjunction with any other game, games, contest, and/or contests, in which the respective game, games, contest, and/or contests, can be segmented into plays which can facilitate a viewer, listener, or spectator, attempting to guess or anticipate a play or action and, thereafter, facilitating the ability to compare the anticipated with the actual play or action with the viewer's, listener's, or spectator's, anticipated play, action, and/or guess.

The apparatus 100 can record the viewer's, listener's, or spectator's, anticipated plays, actions, and/or guesses, compare same with the actual plays and/or actions, and determine and/or calculate a score for the viewer, listener, or spectator. The score can be a score indicative of a viewer's, listener's, or spectator's, successes at correctly anticipating plays or actions. The score can also be a score indicative of a viewer's, listener's, or spectator's, inability to correctly anticipate plays or actions.

It is envisioned that, in order to promote viewer-ship with its attendant advantages (i.e. increased advertisement exposure, increased commercial exposure, increased fan participated, team souvenir sales, etc.), broadcasters, media providers, team owners, producers, disseminators and/or sponsors, of any respective program, event, game, commercial, advertisement, and/or marketing information, and/or advertisers or marketers, can sponsor viewer, listener, or spectator, game strategy, game participation, and/or other, contests which can award monetary and/or other prizes, to contest winners. The prizes can include cash prizes, goods, products, services, tickets to games, trips, private lessons from a player or players, and/or any other prize, etc.

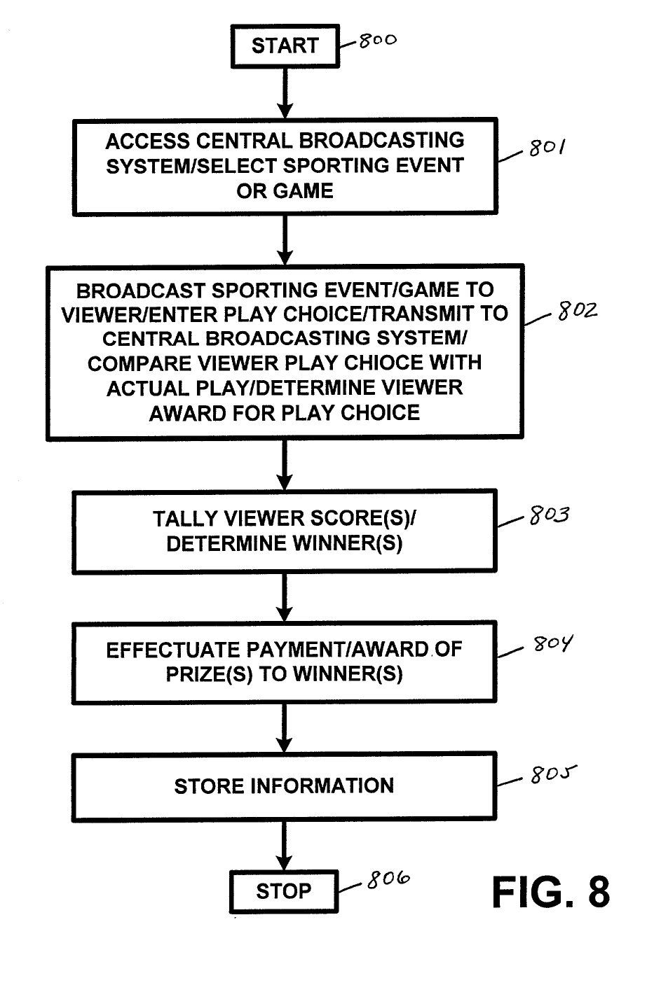

FIG. 8 illustrates another preferred embodiment method for utilizing the apparatus 100 of the present invention. The embodiment of FIG. 8 can be utilized in conjunction with an interactive television, an interactive radio, and/or any of the other user devices 20 described herein. The embodiment of FIG. 8 can also be utilized by spectators at the game venue, stadium, and/or arena, by utilizing user devices 20 which can be any one or more of devices located at their seats, wireless or mobile telephones, cellular telephones, hand-held devices, personal digital assistants, videophones, and/or other communication devices. In this manner, the apparatus 100 of FIG. 8 can be utilized by viewers, listeners, and/or spectators, who are present at game.

With reference to FIG. 8, the operation of the apparatus commences at step 800. At step 801, the viewer, listener, or spectator, can access the central broadcasting system 10 and/or the location broadcasting system 30 and select the game or sporting event which he or she desires to view or to which he or she desires to listen. At step 802, the broadcast of the game or sporting event can be provided to the user device 20.

At any time during step 802, the viewer, listener, or spectator, can enter his or her play choice or choices into his or her user device 20 and transmit same to the central broadcasting system 10 and/or the location broadcasting system 30. The play of play choices can include any number and/or types of plays or actions which can be made by and/or performed by any of the players on either the offensive team and/or the defensive team (i.e. the batting team, the fielding team, the offensive team, the defensive team, the special team, etc.).

The respective central processing computer 10B and/or the central processing computer 30B can compare viewer's, listener's, or spectator's, play choice or choices against information regarding the actual play. The actual play information can be entered by a game official or other official individual who is designated to enter same into the central processing computer 10B and/or the central processing computer 30B.

At step 802, the respective central processing computer 10B and/or the central processing computer 30B can compare the actual play information against the viewer's, listener's, or spectator's, play choice or choices. At step 802, the respective central processing computer 10B and/or the central processing computer 30B can award a point to the viewer, listener, or spectator, for a play which was correctly anticipated and/or picked.

Depending upon the game rules of the particular game, the viewer, listener, or spectator, can receive a point or points when correct, receive no points for a wrong pick, lose points for a wrong pick, and/or bet any number of points on any pick and either win or lose the wagered number of points depending upon the play's outcome. The above operation, at step 802 will continue and/or be repeated for any amount of plays and/or for any portion of, and/or the full duration of, the game or sporting event.

At step 803, upon the completion of the viewer's, listener's, or spectator's, play and/or upon the conclusion of the game or sporting event, the respective central processing computer 10B and/or the central processing computer 30B will calculate or tally the scores of any participating viewer or viewers, determine a winner or winners and any respective prizes won by the winner or winners.

At step 804, the respective central processing computer 10B and/or the central processing computer 30B can effectuate payment and/or transfer of the prize or prizes to winning viewers, listeners, or spectators. For example, the respective central processing computer 10B and/or the central processing computer 30B can effectuate an electronic funds transfer from an account(s) associated with a sponsoring broadcasters, media providers, team owners, producers, disseminators and/or sponsors, of any respective program, event, game, commercial, advertisement, and/or marketing information, and/or advertisers or marketers, to an account associated with a viewer(s), listener(s), or spectator(s). The respective central processing computer 10B and/or the central processing computer 30B can also facilitate the shipment, delivery, and/or transfer, of any prize or prizes to any viewer(s), listener(s), or spectator(s).

At step 805, any information relating the herein-described games, and/or the participants, and/or winners and/or losers of same can be stored in the respective database 10J and/or 30J.

Thereafter, the operation of the apparatus 100 will cease at step 806.

In another preferred embodiment, the apparatus 100 of the present invention can be utilized in order to allow a viewer to select and/or control the selection of any one or more of cameras, video cameras, television cameras, video recorders, microphones, and/or audio recorders, which are utilized in the broadcast of any one or more of the herein-described programs, television programs, television shows, radio programs, news broadcasts, events, performances, television game shows, game shows, games, contests, and/or sporting events.

In this embodiment, the viewer can also request and receive instant replays, on-demand, and/or instant replays recorded by multiple cameras and/or microphones. The apparatus of this embodiment can also provide split screen displays and/or multiple screen displays for viewing the recordings of any number or plurality of cameras on the display of the user device 20.

The apparatus 100 of this embodiment can also provide instant replays along with life broadcast information to, for example, allow a viewer to watch, in split screen or multiple screen format, an instant replay, or instant replays, of a prior play or portion the performance while the live or taped broadcast continues to be displayed on the user device 20. The apparatus of this embodiment can also provide for viewer ordering of a video recording of any portion of, and/or an entire, program, television program, television show, radio program, news broadcast, event, performance, television game show, game show, game, contest, and/or sporting event, for later viewing on-demand.

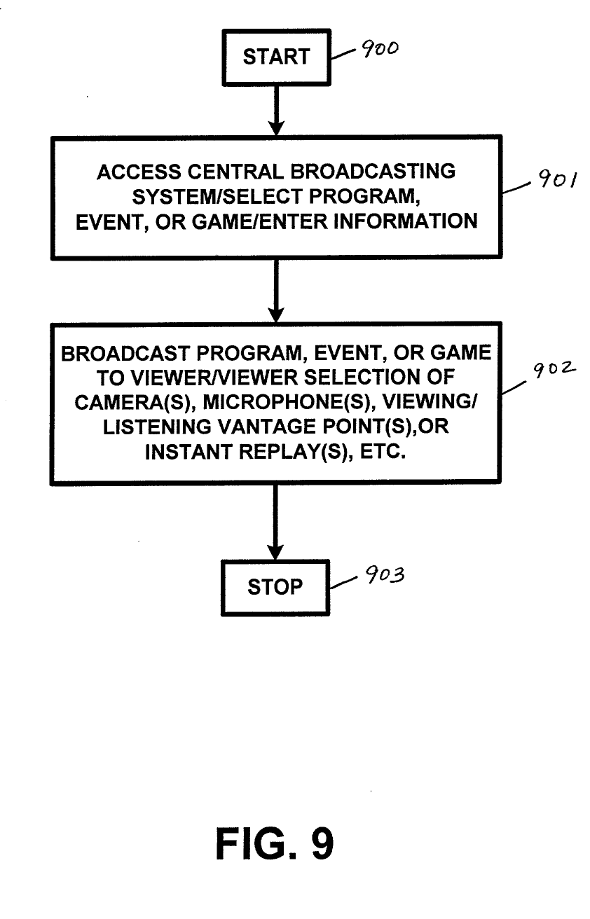

FIG. 9 illustrates another preferred embodiment method for utilizing the apparatus 100 of the present invention, if flow diagram form.

In the preferred embodiment of FIG. 9, the apparatus 100 is described as being utilized in conjunction with the broadcasting of a sporting event, such as, but not limited to, a baseball game, football game, basketball game, hockey game, soccer game, tennis match, and/or any other sporting event or game, etc. It is, however, to be understood that the apparatus 100 of FIG. 9 can also be utilized to perform or provide any of the above-described functionality in conjunction with programs, television programs, television shows, radio programs, news broadcasts, events, performances, television game shows, game shows, games, contests, and/or sporting events, of any kind or type.

For example, the apparatus 100 of FIG. 9 can be used to select a camera for viewing a play, a television program, a movie, a concert performance, to view instant replays of portions of same and/or to perform any other function described herein as being facilitated by the apparatus 100 of FIG. 9.

With reference to FIG. 9, the operation of the apparatus 100 commences at step 900. At step 901, the viewer can access the respective central broadcasting system 10 and/or location broadcasting system 30 and select the program, television program, television show, radio program, news broadcast, event, performance, television game show, game show, game, contest, and/or sporting event, which he or she desires to view. As an example, the viewer can select a football game to view.

At step 901, the viewer can preprogram information regarding the cameras from which he or she desires to view the game, and/or pre-order instant replays of certain plays (i.e. first downs, touchdowns, scoring plays, penalties, pass interceptions, etc.).

At step 902, the game can be broadcast to the viewer on the user device 20 which can be an interactive television and/or any other user device 20 described herein. At any time during the game broadcast, prior to the game broadcast, and/or at any other time, the viewer can, via the user device 20, transmit a signal to the respective central processing computer 10B and/or central processing computer 303 in order to select the camera or cameras, of the respective location broadcasting system 30, from which the viewer desires to view the game, and/or select the microphone or microphones, of the respective location broadcasting system 30, from which the viewer may listen to the game.

For example, the viewer can select a camera located at mid-field, a camera in the end zone, an upper deck camera, a rooftop camera, a field level camera, and/or a camera located at any point or location in and/or on the respective stadium, arena, or venue. The viewer can also select a camera located on a hovering blimp. The viewer can also select a microphone from which to listen to the game. The viewer can select a broadcaster's microphone, a team bench microphone, a referee's or game official's microphone, a stadium or field microphone, and/or any other microphone.

The viewer can select a camera from a menu of split screen and/or multiple screen video lives, live or otherwise, from any number of available cameras. The viewer can select a microphone from a menu of microphone locations or platforms, live or otherwise, from any number of available microphones. Applicant hereby incorporates by reference herein the subject matter and teachings of U.S. Pat. No. 5,917,405.

At any time during the broadcast of the game, at step 902, the viewer can select and/or change viewing camera(s), listening microphone(s), view the game from multiple camera angles, listen to the game from different listening microphones, and/or otherwise utilize the video and/or audio obtained from the respective and different cameras and/or microphones which are available for use. For example, the viewer can view the game from mid-field, and continue to select different viewing cameras and/or listening microphones as the game progresses. The selection and/or the changing of viewing cameras and/or listening microphones can take place in real-time and/or otherwise.

The providing of the video from the selected camera(s) and/or the audio from the selected microphone(S) can be provided to the viewer any one or more of instantly, near instantly, in real-time, in a time-delayed manner, and/or in any other manner which can be provided by the apparatus 100. In the preferred embodiment, it is desired to provide the video and/or the audio from the respectively selected camera(s) and/or microphone(s) as quickly after the selection is made as possible and/or as quickly as the apparatus 100 and/or any components and/or components systems of same will allow.

At any time during step 902, the viewer can order or request an instant reply or instant replays of a play or action. The viewer can request or order multiple instant replays of a play or action from different cameras, from different camera angles, and/or from different vantage points. The instant replay or replays can be transmitted from the respective location broadcasting system 30 to the user device 20.

The instant reply or replays can be provided to the viewer in regular single screen format, in split screen format, in multiple screen format, and/or in any other appropriate manner. The instant reply or replays can be provided to the viewer in conjunction with the continuing live broadcast, in regular single screen format, in split screen format, in multiple screen format, and/or in any other appropriate manner.

At any time during step 902, the viewer can request and obtain video, audio, instant replays, and/or game information, and/or game background information, from the central broadcasting system 10 and/or from the location broadcasting system 30. At any time during step 902, and/or at any time after the game, the viewer can order from the from the central broadcasting system 10 and/or from the location broadcasting system 30, a video recording, or a video tape, of the entire game and/or a portion of the game.

Thereafter, the operation of the apparatus 100 will cease at step 903.

The apparatus 100 of FIG. 9 can be utilized in conjunction with any type or kind of program, television program, television show, radio program, news broadcast, event, performance, television game show, game show, game, contest, and/or sporting event, in a same, a similar, and/or an analogous, manner as described above.

In another preferred embodiment, the apparatus 100 of the present invention can be utilized in order to conduct elections and/or to vote in elections, of any kind. The apparatus 100 can be utilized by users, individual, or viewers, to vote in elections for public offices, organization elections, corporate and/or private elections, union elections, and/or any other elections or campaigns.

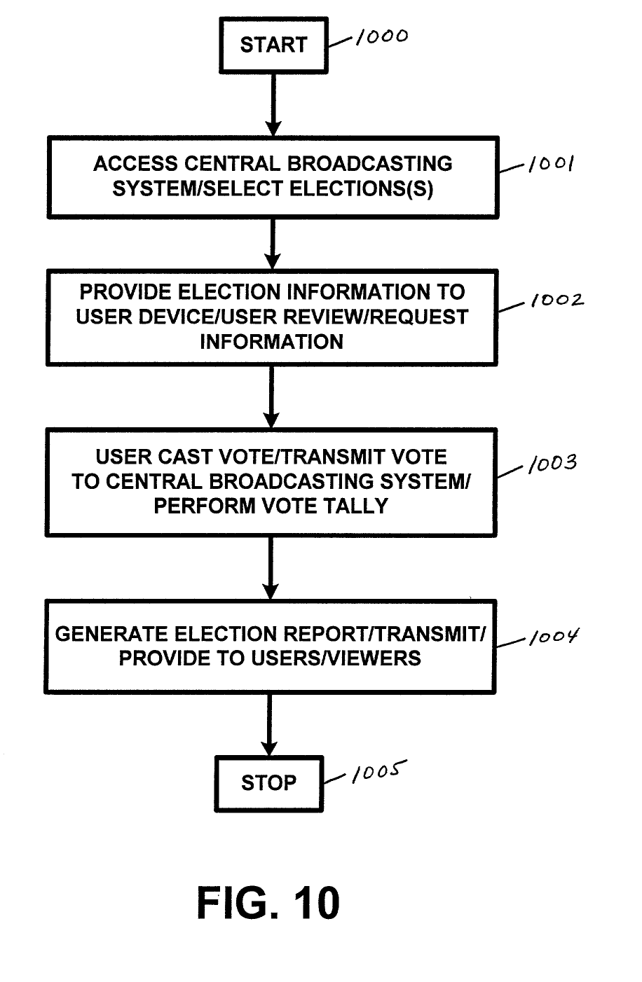

FIG. 10 illustrates another preferred embodiment method for utilizing the apparatus 100 of the present invention, in flow diagram from. With reference to FIG. 10, the operation of the apparatus 100 commences at step 1000.

At step 1001, the user, individual, viewer, can access the central broadcasting system 10 and/or the central processing computer 10B which is conducting and/or administering the election. Although described as being administered by a central broadcasting system 10 and/or the central processing computer 10B, the election can also be administered by the location broadcasting system 30 and/or the central processing computer 30B and/or can be administered by both the central broadcasting system 10, and/or the central processing computer 10B, and the location broadcasting system 30, and/or the central processing computer 30B.

At step 1001, the user, individual, or viewer, can select the election, elections, or group of elections, in which he or she desires to vote. At step 1002, the central broadcasting system 10 can transmit and/or otherwise provide the election information to the user device.

The election information can contain the information regarding the particular elective office or position and the slate of candidates for the office or position. The viewer, at step 1002, can review the provided information. The information can be in the form of text information, video information, audio information, audio and video information, video clips, audio clips, campaign information, campaign commercials, candidate biographical information, candidate endorsements, organization endorsements, and/or any other information which can be related to, and/or which can be pertinent to, the candidates and/or the election.

At step 1002, the candidate can request any other or additional information regarding the elective office and/or any of the candidates seeking same. At step 1002, the central broadcasting system 10 and/or the central processing computer 10B can provide the requested information to the user device.

At step 1003, the user, individual, or viewer, can cast his or her vote for the desired candidate. At step 1003, the central broadcasting system 10 and/or the central processing computer 10B, can receive the user's, individual's, or viewer's, vote and tally same with other votes cast in the same election.

The above process of steps 1002 and 1003 can be repeated for each of the elections or groups of elections selected by the user, individual, or viewer.

When the election time period has ended, the central broadcasting system 10 and/or the central processing computer 10B, will compile all of the results and announce the election winner.

At step 1004, the central broadcasting system 10 and/or the central processing computer 10B, can then provide information regarding the election winners to user device 20 associated with the user, individual, or viewer. The information can be provided as an election report, a report or program containing video information, audio information, text information, audio and video information, and/or any combination of same. The election report can be generated by the central processing computer 10B.

The election report can also be provided to the user, individual, or viewer, in the form of an e-mail message, a telephone message, a facsimile message, a physical mail delivery, an electronic transmission, a beeper message, a pager message, and/or any other message and/or electronic transmission.

Thereafter, the operation of the apparatus 100 will cease at step 1005.

In any and/or all of the embodiments described herein, information can be provided to the respective users, individuals, viewers, listeners, broadcasters, media providers, team owners, producers, disseminators and/or sponsors, of any respective program, event, game, commercial, advertisement, and/or marketing information, and/or advertisers or marketers, and/or to their respective user devices, and/or broadcasting systems, via any one or more of television transmissions, radio transmissions, cable television transmissions, telephone transmissions, voice over Internet transmissions or communications, telephone over Internet transmissions or communications, voice over IP transmissions, facsimile transmissions, pager messages, beeper messages, e-mail transmissions or messages, instant messaging messages or transmissions, and/or electronic transmissions of any kind or type.

In any and/or all of the embodiments described herein, the viewer or listener can communicate with, converse with, speak to, and/or transmit messages to, to any of the broadcasters, media providers, team owners, producers, disseminators and/or sponsors, of any respective program, event, game, commercial, advertisement, and/or marketing information, advertisers, marketers, actors, hosts, directors, newscasters, broadcasters, event performers, performers, game contestants, game players, athletes, professional sports athletes, professional sports players, amateur sports athletes, amateur sports players, and/or any other individuals, by any one or more of voice conversation, telephone conversation, videophone conversation, audio and video telephone conversation, Internet telephony conversation, speaking directly with an individual, text messaging, instant messaging, e-mail message, facsimile messaging, and/or via a other appropriate manners or techniques, and/or via any combination of same.

In any and/or all of the embodiments described herein, any of the broadcasters, media providers, team owners, producers, disseminators and/or sponsors, of any respective program, event, game, commercial, advertisement, and/or marketing information, and/or advertisers or marketers, can have a user device 20 associated therewith for utilizing the apparatus 100 and/or for obtaining any of the herein-described programs, a television show, television shows, a television game show, television game shows, a movie, movies, a radio program, radio programs, a marketing program, marketing programs, an infomercial, infomercials, marketing information, a commercial, commercials, and/or other information described herein as being provided by the apparatus 100.

In any and/or all of the embodiments described herein, the respective databases 10J, 20J, and/or 30J, can contain any of the herein-described information described herein as being provided and/or as being processed by the apparatus 100 of the present invention. The respective databases 10J, 20J, and/or 30J, can also contain any data and/or information needed and/or desired for providing any of the herein-described information and/or for performing any of the herein-described processing routines and/or functionality.

In any and/or all of the embodiments described herein, the apparatus 100, the central processing computer(s) 10B, and/or the central processing computer(s) 30B, can administer and/or maintain a financial account(s) for, or on behalf of, any of the herein-described and/or herein-defined users, individuals, viewers, listeners, broadcasters, media providers, team owners, producers, disseminators and/or sponsors, of any respective program, event, game, commercial, advertisement, and/or marketing information, and/or advertisers or marketers, who or which utilize the apparatus and method of the present invention. The financial accounts may be bank accounts, electronic money accounts, credit accounts, debit account, charge accounts, and/or any other accounts for facilitating financial transactions.

The apparatus 100, the central processing computer(s) 10B, and/or the central processing computer(s) 30B, can make a payment and/or a transfer for, or on behalf of, any of the herein-described and/or herein-defined users, individuals, viewers, listeners, broadcasters, media providers, team owners, producers, disseminators and/or sponsors, of any respective program, event, game, commercial, advertisement, and/or marketing information, and/or advertisers or marketers, and/or can receive a payment and/or a transfer for, or on behalf of, any of the herein-described and/or herein-defined users, individuals, viewers, listeners, broadcasters, media providers, team owners, producers, disseminators and/or sponsors, of any respective program, event, game, commercial, advertisement, and/or marketing information, and/or advertisers or marketers, whichever the case may be.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of any of the respective users, individuals, viewers, listeners, broadcasters, media providers, team owners, producers, disseminators and/or sponsors, of any respective program, event, game, commercial, advertisement, and/or marketing information, and/or advertisers or marketers, described herein as utilizing the apparatus 100 of the present invention, so as to act on behalf of the respective users, individuals, viewers, listeners, broadcasters, media providers, team owners, producers, disseminators and/or sponsors, of any respective program, event, game, commercial, advertisement, and/or marketing information, and/or advertisers or marketers, as well as to perform any of processing functions and/or other functions described herein.

The intelligent agent can act on behalf of the respective users, individuals, viewers, listeners, broadcasters, media providers, team owners, producers, disseminators and/or sponsors, of any respective program, event, game, commercial, advertisement, and/or marketing information, and/or advertisers or marketers, in various activities which are described as being performed herein and/or which may be incidental and/or related thereto. Therefore, the present invention also provides an agent-based apparatus and method for facilitating viewer or listener interaction.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

Applicant also hereby incorporates by reference herein the subject matter and teachings of the following U.S. Patents:

U.S. Pat. No. 6,151,626 Interactive television communication system

U.S. Pat. No. 6,148,081 Security model for interactive television applications

U.S. Pat. No. 6,078,800 Method and device for reducing RF transmission interference and use thereof in an interactive television network

U.S. Pat. No. 6,075,527 Interactive television system

U.S. Pat. No. 6,061,097 Interactive television program guide with selectable non-program options

U.S. Pat. No. 6,038,319 Security model for sharing in interactive television applications

U.S. Pat. No. 6,018,710 Web-based interactive radio environment: WIRE

U.S. Pat. No. 6,016,141 Interactive television program guide system with pay program package promotion

U.S. Pat. No. 6,014,569 Mobile interactive radio

UE36,368 Automatic interactive television terminal configuration

U.S. Pat. No. 5,936,661 Interactive television game system

U.S. Pat. No. 5,929,850 Interactive television system and method having on-demand web-like navigational capabilities for displaying requested hyperlinked web-like still images associated with television content

U.S. Pat. No. 5,903,816 Interactive television system and method for displaying web-like stills with hyperlinks

U.S. Pat. No. 5,903,262 Interactive television system with script interpreter

U.S. Pat. No. 5,900,905 System and method for linking video, services and applications in an interactive television system

U.S. Pat. No. 5,898,919 Cordless phone back link for interactive television system

U.S. Pat. No. 5,897,623 Interface method for providing information about items on a list for interactive television

U.S. Pat. No. 5,880,720 Television system for providing interactive television programs and server system for constructing the television system

U.S. Pat. No. 5,867,208 Encoding system and method for scrolling encoded MPEG stills in an interactive television application

U.S. Pat. No. 5,844,620 Method and apparatus for displaying an interactive television program guide

U.S. Pat. No. 5,835,717 System and method for saving state information in an interactive television system

U.S. Pat. No. 5,818,440 Automatic execution of application on interactive television

U.S. Pat. No. 5,812,931 Two-way interactive television system incorporating pager transmitter and receiver for conducting messaging with information provider

U.S. Pat. No. 5,805,155 Virtual assets in an interactive television cable system

U.S. Pat. No. 5,802,284 System and method using cover bundles to provide immediate feedback to a user in an interactive television environment

U.S. Pat. No. 5,764,275 Interactive television security through transaction time stamping

U.S. Pat. No. 5,734,413 Transaction based interactive television system

U.S. Pat. No. 5,721,583 Interactive television system for implementing electronic polling or providing user-requested services based on identification of users or of remote control apparatuses which are employed by respective users to communicate with the system

U.S. Pat. No. 5,675,373 Interactive television service utilizing both unidirectional and omnidirectional broadcasting

U.S. Pat. No. 5,668,592 Interactive television terminal responsive to user commands which combines static service data and recurrently broadcast dynamic service data to produce composite service display signals

D383,456 Television set top converter box for interactive television

U.S. Pat. No. 5,638,113 Transaction based interactive television system

U.S. Pat. No. 5,633,872 Interactive radio

U.S. Pat. No. 5,619,250 Operating system for interactive television system set top box utilizing dynamic system upgrades

U.S. Pat. No. 5,610,665 Interactive television graphics interface

U.S. Pat. No. 5,600,368 Interactive television system and method for viewer control of multiple camera viewpoints in broadcast programming

U.S. Pat. No. 5,583,563 Method and system for delivering an application in an interactive television network

U.S. Pat. No. 5,570,126 System for composing multimedia signals for interactive television services

U.S. Pat. No. 5,561,708 Method and apparatus for interactive television through use of menu windows

U.S. Pat. No. 5,530,469 Interactive television with correlation of viewers input and results made available to each viewer

U.S. Pat. No. 5,526,035 Transaction based interactive television system

U.S. Pat. No. 5,524,273 Overlapping non-interactive radio patch method

U.S. Pat. No. 5,524,195 Graphical user interface for interactive television with an animated agent

D370,481 Decoder box for interactive television set

U.S. Pat. No. 5,519,433 Interactive television security through transaction time stamping

U.S. Pat. No. 5,517,257 Video control user interface for interactive television systems and method for controlling display of a video movie

U.S. Pat. No. 5,504,896 Method and apparatus for controlling program sources in an interactive television system using hierarchies of finite state machines

D363,287 Remote controller for an interactive television system

U.S. Pat. No. 5,446,490 Interactive television with tailored programming

U.S. Pat. No. 5,442,389 Program server for interactive television system

U.S. Pat. No. 5,423,555 Interactive television and video game system

D357,685 Modem for an interactive television system

U.S. Pat. No. 5,404,393 Method and apparatus for interactive television through use of menu windows

U.S. Pat. No. 5,355,480 Storage control method and apparatus for an interactive television terminal

U.S. Pat. No. 5,343,239 Transaction based interactive television system

U.S. Pat. No. 5,321,514 Interactive television and data transmission system

RE34,340 Closed circuit television system having seamless interactive television programming and expandable user participation

U.S. Pat. No. 5,177,604 Interactive television and data transmission system

U.S. Pat. No. 4,991,011 Interactive television terminal with programmable background audio or video

U.S. Pat. No. 4,987,486 Automatic interactive television terminal configuration

U.S. Pat. No. 4,918,516 Closed circuit television system having seamless interactive television programming and expandable user participation

U.S. Pat. No. 4,847,700 Interactive television system for providing full motion synched compatible audio/visual displays from transmitted television signals

U.S. Pat. No. 4,847,698 Interactive television system for providing full motion synched compatible audio/visual displays

U.S. Pat. No. 4,750,036 Interactive television and data transmission system

U.S. Pat. No. 4,034,990 Interactive television gaming system

While the present invention has been described and illustrated in various preferred and alternate embodiments, such descriptions are merely illustrative of the present invention and are not to be construed to be limitations thereof. In this regard, the present invention encompasses all modifications, variations, and/or alternate embodiments, with the scope of the present invention being limited only by the claims which follow.

What is claimed is:

1. An apparatus for facilitating viewer and/or listener interaction, comprising:
a receiver for receiving at least one of a broadcast of at least one of a program, an event, a game, and information, from a broadcasting system, and a transmission of information from a central processing computer;
a communication device for facilitating communication between a viewer or listener and at least one of a participant in, and an individual located at a venue of, the at least one of a program, an event, and a game;
an input device for inputting at least one of viewer or listener interactive information and viewer or listener participation information;
a processor for processing the at least one of viewer or listener interactive information and viewer or listener participation information; and
a transmitter for transmitting the at least one of viewer or listener interactive information and viewer or listener participation information to the central processing computer.

2. The apparatus of claim 1, wherein the viewer or listener participates in at least one of a program, an event, and a game, at least one of alone and in conjunction with another individual.

3. The apparatus of claim 2, wherein the receiver receives information regarding at least one of a prize, winnings, and compensation, for the viewer's or listener's at least one of interaction with, and participation in, the at least one of a program, an event, and a game.

4. The apparatus of claim 1, wherein the at least one of a program, an event, and a game, is at least one of a television program, a radio program, a program, an event, a game, a game show, a sporting event, a television show, a television game show, a radio game show, a movie, a marketing program, an infomercial, an advertisement, and a commercial.

5. The apparatus of claim 1, wherein the apparatus is at least one of an interactive television, an interactive radio, a computer, a personal computer, a telephone, a wireless telephone, a personal digital assistant, a video telephone, a videophone, a television, a radio, a two-radio, a personal communication device, a wireless device, a handheld device, a palm-top device, and a watch.

6. The apparatus of claim 1, wherein at least one of the participant and the individual is at least one of an actor, a host, a director, a newscaster, a broadcaster, an event performer, a performer, a game contestant, a game player, an athlete, a professional sports athlete, a professional sports player, an amateur sports athlete, and an amateur sports player.

7. The apparatus of claim 1, wherein the venue is at least one of a studio, a set, a stage, a performance hall, a stadium, a arena, a playing field, and a playing court.

8. The apparatus of claim 1, wherein the viewer or listener communicates with at least one of the participant and the individual by at least one of voice conversation, telephone conversation, videophone conversation, audio and video telephone conversation, Internet telephony conversation, speaking directly with an individual, text messaging, instant messaging, e-mail message, and facsimile messaging.

9. The apparatus of claim 1, wherein the broadcasting system comprises at least one of a camera, a video recording device, a microphone, an audio recording device, and a transmitter.

10. An apparatus for facilitating viewer and/or listener interaction, comprising:
a receiver for receiving at least one of viewer or listener interactive information and viewer or listener participation information regarding at least one of an anticipated next play and an anticipated activity in at least one of a program, an event, and a game, wherein the at least one of viewer or listener interactive information and viewer or listener participation information is received from a user device associated with the viewer or listener;
a processor for processing the at least one of viewer or listener interactive information and viewer or listener participation information, wherein the processor compares the at least one of viewer or listener interactive information and viewer or listener participation information with at least one of a play, an activity, and an answer, which occurs in the at least one of a program, an event, and a game, and further wherein the processor compiles a score indicative of a viewer's or listener's ability to correctly anticipate at least one of a play, an activity, and an answer, in the at least one of a program, an event, and a game, and further wherein the processor determines at least one of a prize, winnings, and compensation, earned by the viewer or listener, and further wherein the processor generates a report containing information regarding the viewer's or listener's score and at least one of a prize, winnings, and compensation, earned by the viewer or listener; and
a transmitter for transmitting the report to the user device.

11. The apparatus of claim 10, wherein the at least one of a play, an activity, and an answer, is at least one of a play, an action, an activity, and an answer, in at least one of a game, a sporting event, a game show, and a contest.

12. The apparatus of claim 10, wherein the at least one of a program, an event, and a game, is at least one of a television program, a radio program, a program, an event, a game, a game show, a sporting event, a television show, a television game show, a radio game show, a movie, a marketing program, an infomercial, an advertisement, and a commercial.

13. The apparatus of claim 11, wherein the user device is at least one of an interactive television, an interactive radio, a computer, a personal computer, a telephone, a wireless telephone, a personal digital assistant, a video telephone, a videophone, a television, a radio, a two-radio, a personal communication device, a wireless device, a handheld device, a palm-top device, and a watch.

14. The apparatus of claim 10, wherein the at least one of a program, an event, and a game, is broadcast to the user device by a broadcasting system.

15. The apparatus of claim 14, wherein the broadcasting system comprises at least one of a camera, a video recording device, a microphone, an audio recording device, and a transmitter.

16. The apparatus of claim 10, wherein the processor processes information regarding multiple at least one of plays, activities, and answers.

17. An apparatus for facilitating viewer and/or listener interaction, comprising:
a receiver for receiving at least one of viewer or listener interactive information, wherein the viewer or listener interactive information contains information regarding a viewer's or listener's selection of at least one of a viewing at least one of camera, video camera, television camera, and video recorder, a viewer's or listener's selection of at least one of a listening at least one of a microphone and audio recorder, and a viewer's or listener's request to view an instant reply, from a user device associated with the viewer or listener;
a processor for processing the viewer or listener interactive information, wherein the processor generates a control signal in response to the viewer or listener interactive information, wherein the control signal controls the selection of the at least one of a viewing at least one of camera, video camera, television camera, and video recorder, a listening of at least one of microphone and audio recorder, and a viewing of an instant replay; and
a transmitter for at least one of broadcasting at least one of a program, an event, a game, and a portion of the at least one of a program, an event, a game, from the viewer or listener selected at least one of camera, video camera, television camera, video recorder, microphone, and audio recorder, and transmitting the viewer or listener selected instant reply, to the user device.

18. The apparatus of claim 17, wherein the at least one of a program, an event, and a game, is at least one of a television program, a radio program, a program, an event, a game, a game show, a sporting event, a television show, a television game show, a radio game show, a movie, a marketing program, an infomercial, an advertisement, and a commercial.

19. The apparatus of claim 17, wherein the user device is at least one of an interactive television, an interactive radio, a computer, a personal computer, a telephone, a wireless telephone, a personal digital assistant, a video telephone, a videophone, a television, a radio, a two-radio, a personal communication device, a wireless device, a handheld device, a palm-top device, and a watch.

20. The apparatus of claim 17, wherein the at least one of a program, an event, and a game, is broadcast to the user device from a broadcasting system, and further wherein the broadcasting system comprises at least one of a camera, a video recording device, a microphone, an audio recording device, and a transmitter.
